(19) United States
(12) Patent Application Publication
(10) Pub. No.: US 2010/0153239 A1
(43) Pub. Date: Jun. 17, 2010

(54) PROVIDING ACCOUNTING SOFTWARE APPLICATION AS ENTERPRISE SERVICES

(75) Inventors: GUNTHER LIEBICH, Walldorf (DE); KAI-MICHAEL ROESNER, Eggenstein-Leopoldshafen (DE); MARTIN SCHORR, Rauenberg (DE)

Correspondence Address: FISH & RICHARDSON, P.C., PO BOX 1022, MINNEAPOLIS, MN, 55440-1022, US

(73) Assignee: SAP AG

(21) Appl. No.: 12/332,965

(22) Filed: Dec. 11, 2008

(51) Int. Cl. G06Q 10/00; G06Q 30/00

(52) U.S. Cl. 705/30

(57) ABSTRACT

Methods and apparatus, including systems and computer program products, for a services architecture design that provides enterprise services having accounting functionality at the level of an enterprise application. The design includes a set of service operations, process components, and optionally deployment units. Suitable business objects are also described.

### BACKGROUND

This specification relates to data processing systems implemented on computers, and more particular to data processing systems providing services in the nature of web services.

Enterprise software systems are generally large and complex. Such systems can require many different components, distributed across many different hardware platforms, possibly in several different geographical locations. Thus, the architecture of a large software application, i.e., what its components are and how they fit together, is an important aspect of its design for a successful implementation.

Web services are one technology for making the functionality of software applications available to other software, including other applications. A web service is a standards-based way of encapsulating the functionality of an application that other applications can locate and access. A service-oriented architecture is a distributed software model within which functionality is defined as independent web services. Within a service-oriented architecture, web services can be used in defined sequences according to business logic to form applications that enable business processes.

### SUMMARY

This specification describes a services architecture design that provides enterprise services having accounting functionality at the level of an enterprise application. Enterprise services are web services that have an enterprise-level business value.

In its various aspects, the invention can be embodied in systems, methods, and computer program products. For example, a system in one embodiment implements a services architecture design that provides enterprise services having accounting functionality at the level of an enterprise application. The design includes a set of service operations, process components, and optionally deployment units. Suitable business objects are also described.

The subject matter described in this specification can be implemented to realize one or more of the following advantages. Effective use is made of process components as units of software reuse, to provide a design that can be implemented reliably in a cost effective way. Effective use is made of deployment units, each of which is deployable on a separate computer hardware platform independent of every other deployment unit, to provide a scalable design. Service interfaces of the process components define a pair-wise interaction between pairs of process components that are in different deployment units in a scalable way.

Details of one or more implementations of the subject matter described in this specification are set forth in the accompanying drawings and in the description below. Further features, aspects, and advantages of the subject matter will become apparent from the description, the drawings, and the claims.

### BRIEF DESCRIPTION OF THE DRAWINGS

FIGS. 1A, 1B, 1C, 1D, 1E, 1F, 1G, 1H, and 1I collectively illustrate a high-level view of a software architectural design and implementation of a suite of enterprise software services having accounting functionality.

FIG. 2 is a block diagram showing a financial market data management process component.

FIGS. 3A, 3B, 3C, 3D, 3E, 3F, 3G, 3H, and 3I are block diagrams collectively showing an accounting process component.

FIG. 4 is a block diagram showing a financial accounting master data management process component.

FIGS. 5A, 5B, 5C, 5D, 5E and 5F are block diagrams collectively showing a payment processing process component.

FIGS. 6A, 6B, 6C and 6D are block diagrams collectively showing a due item processing process component.

FIG. 7 is a block diagram showing a migration data dispatching process component.

FIG. 8 is a block diagram showing a balance of foreign payment management process component.

FIG. 9 is a block diagram showing a costing process component.

FIG. 10 is a block diagram showing a cash management process component.

Like reference numbers and designations in the various drawings indicate like elements.

### DETAILED DESCRIPTION

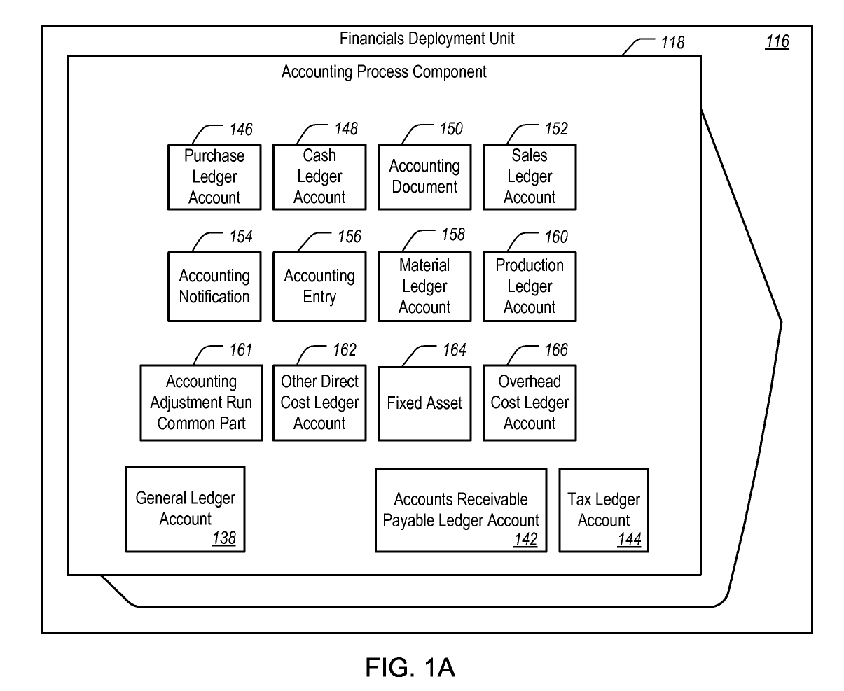

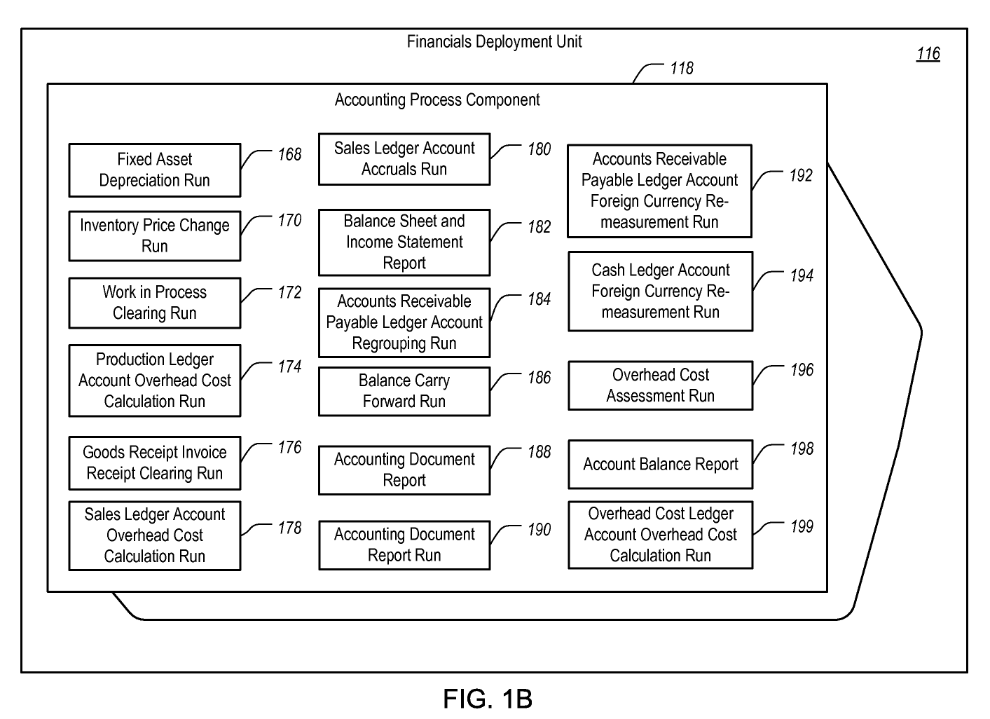

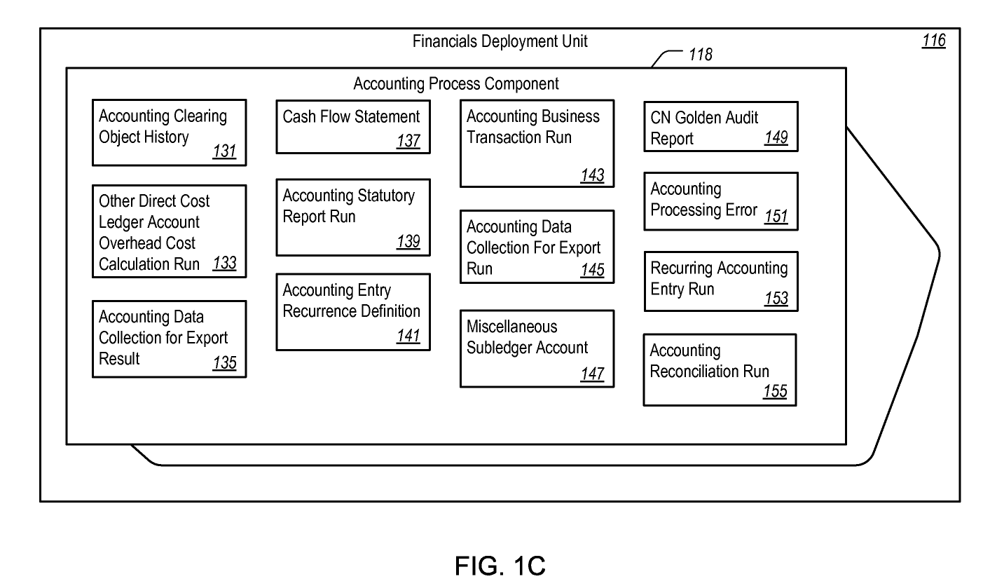

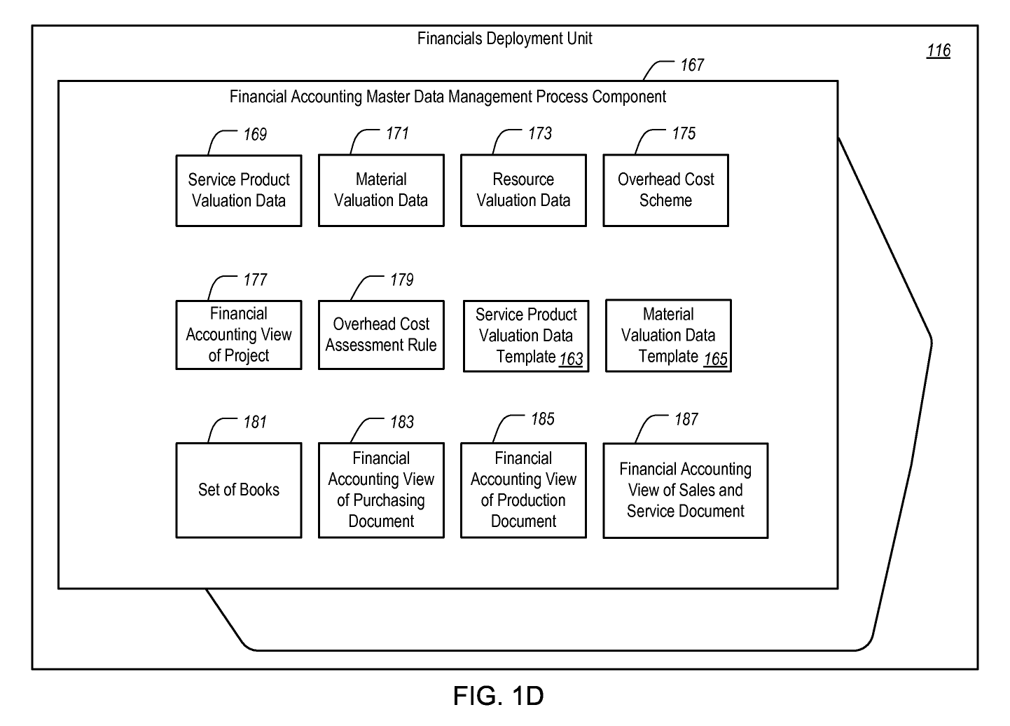

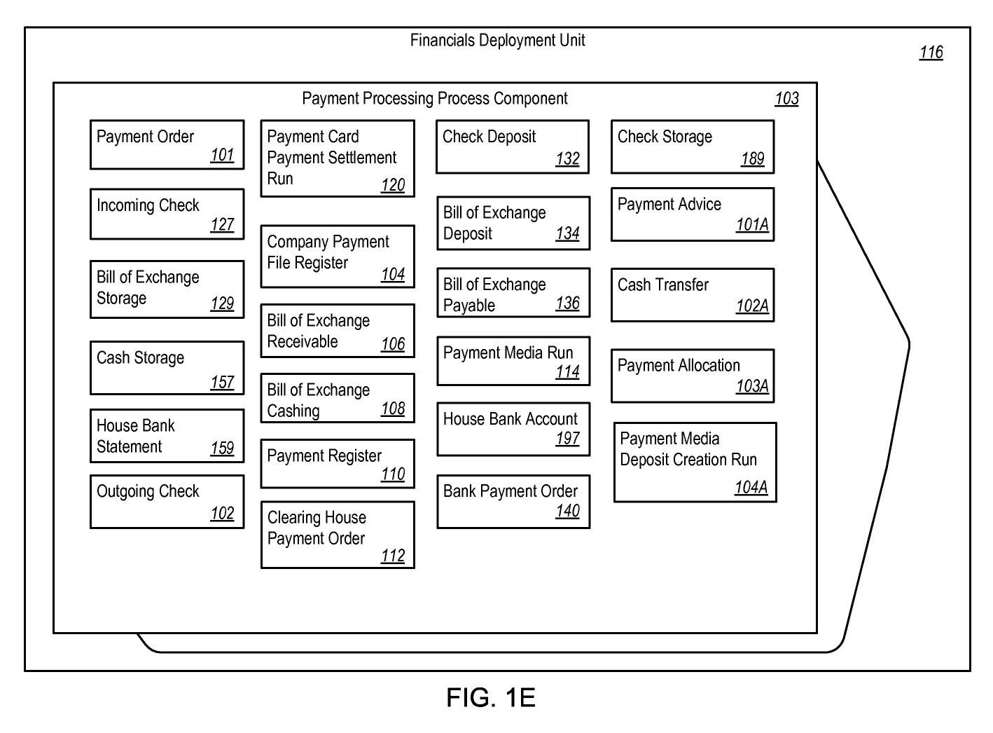

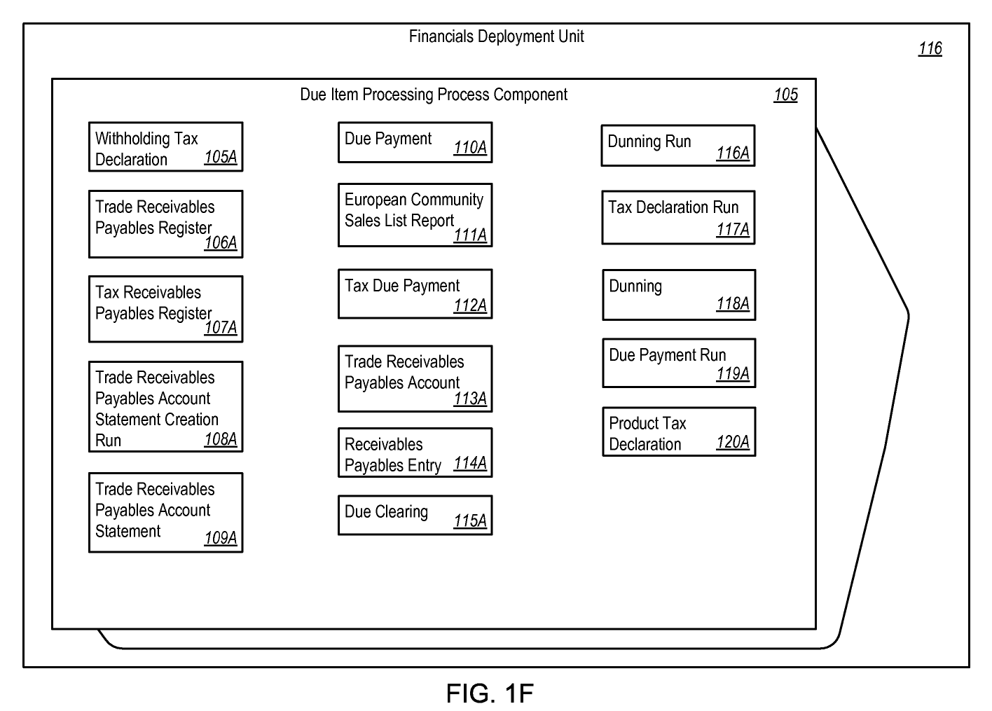

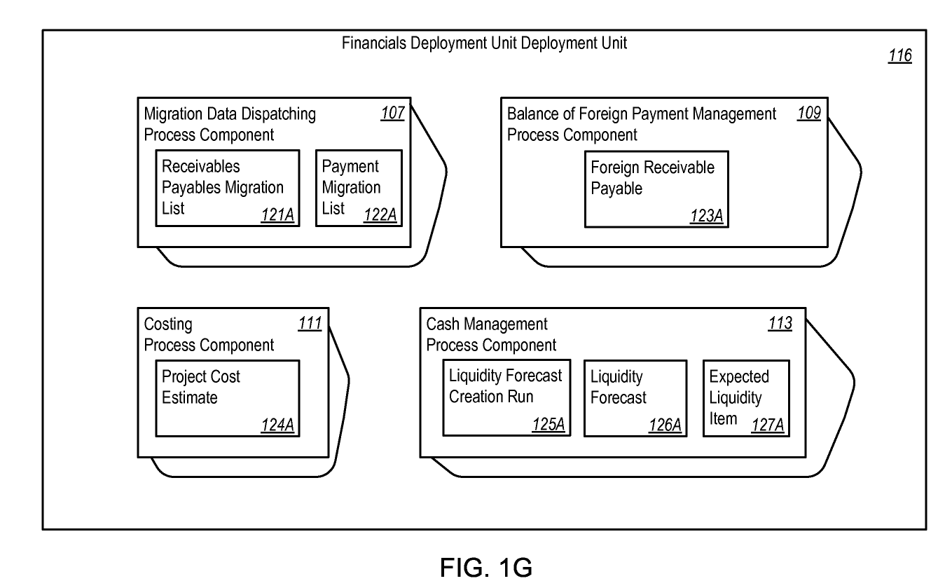

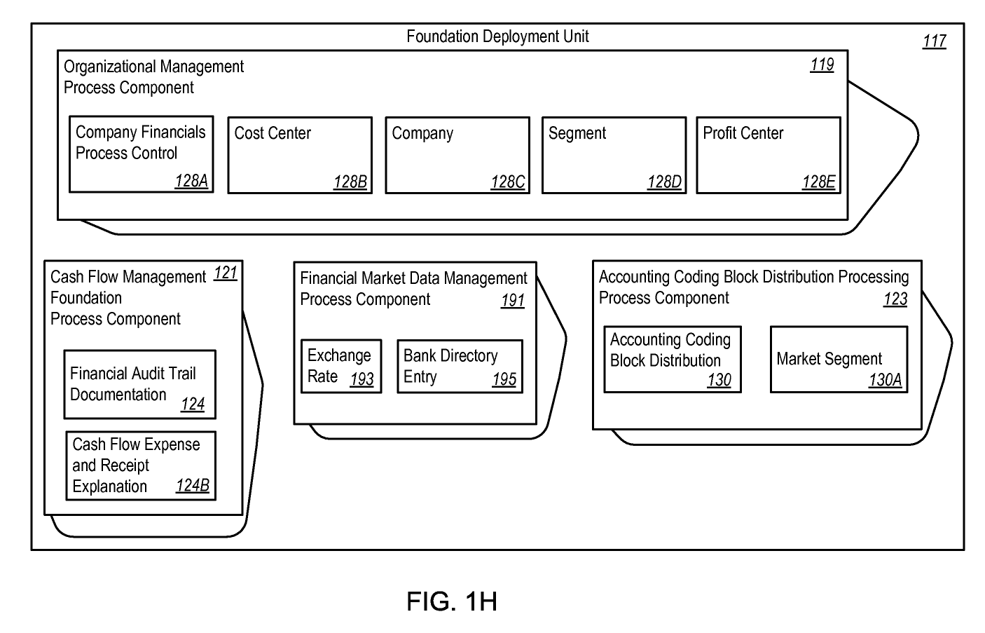

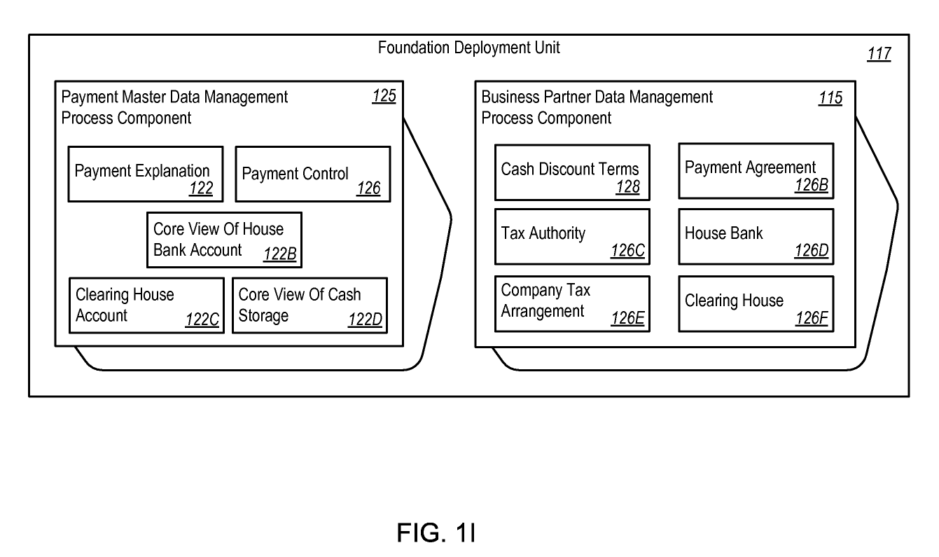

FIGS. 1A, 1B, 1C, 1D, 1E, 1F, 1G, 1H, and 1I collectively illustrate a high-level view of a software architectural design, and of application software implementations of the design, that provides a suite of enterprise service operations, which can be organized into interfaces, having accounting application functionality.

The elements of the architecture include the business object, the process component, the service operation (or simply, the operation), the service interface, the message, and the deployment unit. The elements can also include process agents and reuse service components. These will be generally described below.

In some implementations, the software is implemented to be deployed on an application platform that includes a foundation layer that contains fundamental entities that can used from multiple deployment units. These entities can be process components, business objects or reuse service components. A reuse service component is a piece of software that is reused in different transactions. A reuse service component is used by its defined interfaces, which can be, e.g., local APIs (Application Programming Interfaces) or service interfaces.

The architectural design is a specification of a computer software application, and elements of the architectural design can be implemented to realize a software application that implements enterprise application service interfaces. The elements of the architecture are at times described in this specification as being contained or included in other elements; for example, a process component is described as being contained in a deployment unit. It should be understood, however, that such operational inclusion can be realized in a variety of ways and is not limited to a physical inclusion of the entirety of one element in another.

The architectural elements include the business object. A business object is a representation of a type of a uniquely identifiable business entity (an object instance) described by a structural model. Processes operate on business objects.

A business object represents a specific view on some well-defined business content. A business object represents content, and instances of business objects include content, which a typical business user would expect and understand with little explanation. Whether an object as a type or an instance of an object is intended by the term “object” is generally clear from the context, so the distinction will be made explicitly only when necessary. Also, for convenience and brevity, an object instance may be described in this specification as being or including a real world event, activity, item, or the like; however, such description should be understood as stating that the object instance represents (i.e., contains data representing) the respective event, activity, item, or the like. Properly implemented, business objects are implemented free of redundancies.

Business objects are further categorized as business process objects, master data objects, mass data run objects, dependent objects, and transformed objects. A master data object is an object that encapsulates master data (i.e., data that is valid for a period of time). A business process object, which is the kind of business object generally found in a process component, is an object that encapsulates transactional data (i.e., data that is valid for a point in time). A mass data run object is an application object that executes an algorithm for a particular mass data run, and generally has a name that includes “run”. An instance of a mass data run object embodies or contains a particular set of selections and parameters. A mass data run object implements an algorithm that modifies, manages, and/or processes a large amount of data in multiple transactions, possibly but not necessarily with parallel processing. A dependent object is a business object used as a reuse part in another business object. A dependent object represents a concept that cannot stand by itself from a business point of view. Instances of dependent objects only occur in the context of a non-dependent business object. A transformed object is a transformation of multiple business objects for a well-defined purpose. It transforms the structure of multiple business objects into a common structure. A transformed object does not have own persistency.

The architectural elements also include the process component. A process component is a software package that realizes a business process and generally exposes its functionality as services. The functionality includes the ability to perform all or parts of particular kinds of business transactions. A process component contains one or more semantically related business objects. Any business object belongs to no more than one process component.

Process components are modular and context-independent. That they are context-independent means that a process component is not specific to any specific application and is reusable. The process component is the smallest (most granular) element of reuse in the architecture.

The architectural elements also include the operation. An operation belongs to exactly one process component. A process component generally has multiple operations. Operations can be synchronous or asynchronous, corresponding to synchronous or asynchronous process agents, which will be described below. An operation is the smallest, separately-callable function, described by a set of data types used as input, output, and fault parameters, or some combination of them, serving as a signature. For convenience in supporting use of the operations supported by a system implementing elements of the design, such a system can optionally include a repository of service descriptions that includes a standards-based description of each of the supported service operations.

The architectural elements also optionally include the service interface, which may be referred to simply as an interface. An interface is a named group of operations. Each operation belongs to exactly one interface. An interface belongs to exactly one process component. A process component might implement multiple interfaces. In some implementations, an interface will have only inbound or outbound operations, but not a mixture of both. One interface can include both synchronous and asynchronous operations. All operations of the same type (either inbound or outbound) which belong to the same message choreography will preferably belong to the same interface. Thus, generally, all outbound operations to the same other process component are in one interface.

The architectural elements also include the message. Operations transmit and receive messages. Any convenient messaging infrastructure can be used. A message is information conveyed from one process component instance to another, with the expectation that activity will ensue. An operation can use multiple message types for inbound, outbound, or error messages. When two process components are in different deployment units, invocation of an operation of one process component by the other process component is accomplished by an operation on the other process component sending a message to the first process component.

The architectural elements also include the process agent. Process agents do business processing that involves the sending or receiving of messages. Each operation will generally have at least one associated process agent. A process agent can be associated with one or more operations. Process agents can be either inbound or outbound, and either synchronous or asynchronous.

Asynchronous outbound process agents are called after a business object changes, e.g., after a creation, update, or deletion of a business object instance.

Synchronous outbound process agents are generally triggered directly by a business object.

An outbound process agent will generally perform some processing of the data of the business object instance whose change triggered the agent or caused the agent to be called. An outbound agent triggers subsequent business process steps by sending messages using well-defined outbound services to another process component, which generally will be in another deployment unit, or to an external system. An outbound process agent is linked to the one business object that triggers the agent, but it is sent not to another business object but rather to another process component. Thus, the outbound process agent can be implemented without knowledge of the exact business object design of the recipient process component.

Inbound process agents are called after a message has been received. Inbound process agents are used for the inbound part of a message-based communication. An inbound process agent starts the execution of the business process step requested in a message by creating or updating one or multiple business object instances. An inbound process agent is not the agent of a business object but of its process component. An inbound process agent can act on multiple business objects in a process component.

Synchronous agents are used when a process component requires a more or less immediate response from another process component, and is waiting for that response to continue its work.

Operations and process components are described in this specification in terms of process agents. However, in alternative implementations, process components and operations can be implemented without use of agents using other conventional techniques to perform the functions described in this specification.

The architectural elements also include the deployment unit. A deployment unit includes one or more process components and, optionally, one or more business objects that are deployed together on a single computer system platform. Conversely, separate deployment units can be deployed on separate physical computing systems. For this reason, a deployment unit boundary defines the limits of an application-defined transaction, i.e., a set of actions that have the ACID properties of atomicity, consistency, isolation, and durability. To make use of database manager facilities, the architecture requires that all operations of such a transaction be performed on one physical database; as a consequence, the processes of such a transaction can be performed by the process components of one instance of one deployment unit.

The process components of one deployment unit interact with those of another deployment unit using messages passed through one or more data communication networks or other suitable communication channels. Thus, a deployment unit deployed on a platform belonging to one business can interact with a deployment unit software entity deployed on a separate platform belonging to a different and unrelated business, allowing for business-to-business communication. More than one instance of a given deployment unit can execute at the same time, on the same computing system or on separate physical computing systems. This arrangement allows the functionality offered by a deployment unit to be scaled to meet demand by creating as many instances as needed.

Since interaction between deployment units is through service operations, a deployment unit can be replaced by other another deployment unit as long as the new deployment unit supports the operations depended upon by other deployment units. Thus, while deployment units can depend on the external interfaces of process components in other deployment units, deployment units are not dependent on process component interactions (i.e., interactions between process components involving their respective business objects, operations, interfaces, and messages) within other deployment units. Similarly, process components that interact with other process components or external systems only through messages, e.g., as sent and received by operations, can also be replaced as long as the replacement supports the operations of the original.

Interactions between process components that occur only within a deployment unit are not constrained to using service operations. These can be implemented in any convenient fashion.

In contrast to a deployment unit, the foundation layer does not define a limit for application-defined transactions. Deployment units communicate directly with entities in the foundation layer, which communication is typically not message based. The foundation layer is active in every system instance on which the application is deployed. Business objects in the foundation layer will generally be master data objects. In addition, the foundation layer will include some business process objects that are used by multiple deployment units. Master data objects and business process objects that should be specific to a deployment unit are preferably assigned to their respective deployment unit.

FIGS. 1A, 1B, 1C, 1D, 1E, 1F, 1G, 1H, and 1I collectively illustrate a high-level view of a software architectural design and implementation of a suite of enterprise software services having accounting functionality.

As shown in FIG. 1A, a Financials deployment unit 116 includes an Accounting process component 118. The Accounting process component 118 includes a Purchase Ledger Account business object 146, a Cash Ledger Account business object 148, an Accounting Document business object 150, a Sales Ledger Account business object 152, an Accounting Notification business object 154, an Accounting Entry business object 156, a Material Ledger Account business object 158, a Production Ledger Account business object 160, an Accounting Adjustment Run Common Part business object 161, an Other Direct Cost Ledger Account business object 162, a Fixed Asset business object 164, an Overhead Cost Ledger Account business object 166, a General Ledger Account business object 138, an Accounts Receivable Payable Ledger Account business object 142, and a Tax Ledger Account business object 144.

The Purchase Ledger Account business object 146 contains a record for a company based on the principle of double-entry bookkeeping showing the effects of purchasing transactions, deliveries, and invoice verification on the valuation of the purchased materials and services.

The Cash Ledger Account business object 148 contains a record of valuated liquid assets of a company. The liquid assets are recorded for the purposes for financial reporting when a company produces its profit and loss statement.

The Accounting Document business object 150 represents a business transaction in Financials or Financial Accounting by assigning it to general ledger accounts and to other Financials or Financial Accounting terms.

The Sales Ledger Account business object 152 contains a view of sales activities defined for financial accounting purposes (e.g., for valuation processes). These can include accrued costs and revenues, as well as recognized but not yet confirmed materials and service, and amounts not yet billed. The Sales Ledger Account business object 152 includes the definition, line items, and totals in financial accounting as well as a documentation of changes in value resulting from valuation runs.

The Accounting Notification business object 154 represents a notification sent to Financial Accounting by an operational component regarding a business transaction. The Accounting Notification business object 154 represents this operational business transaction in a standardized form for business transaction documents and contains the data needed to valuate the business transaction.

The Accounting Entry business object 156 is used to directly enter business transactions in Financial Accounting for one or several Set of Books. The Accounting Entry business object 156 does not affect any operational component; therefore it can be used for general ledger entries, cost accounting reassignments, revaluations and other transactions without operational aspects.

The Material Ledger Account business object 158 is a record of the quantities, values, and prices for materials relevant to valuation. The record is used for proper reporting of the company's inventory or income statement.

The Production Ledger Account business object 160 contains a record of the quantities and values of the work in process in production within a company that are relevant to valuation. This record serves the purpose of proper financial reporting of the inventory or profit and loss statement of a company.

The Accounting Adjustment Run Common Part business object 161 represents composition of the constituents of an Accounting Adjustment Run Template, which are common to derived business objects.

The Other Direct Cost Ledger Account business object 162 represents a record of debit and credit entries belonging to a company that shows the effect of business transactions on costs as a result of a particular job or activity. The Other Direct Cost Ledger Account business object 162 represents a classification used in the Other Direct Cost Ledger to collect and report entries. The Other Direct Cost Ledger Account business object 162 represents values that can be directly assigned to a job or project being accomplished and not being recorded in the Production, Sales, or Purchasing Ledger to evaluate profitability. Beyond business transaction related entries, the Other Direct Cost Ledger Account business object 162 contains period-related totals summarizing the entries. The Other Direct Cost Ledger Account business object 162 can be used for recording research and development costs or expenses for an advertising campaign for example.

The Fixed Asset business object 164 represents a view, defined for the purposes of financial accounting, of usually one or more physical objects, rights or other economic values belonging to a company. These are in long-term use, are recognized in the financial statements at closing, and can be individually identifiable. The Fixed Asset business object 164 includes the recording of the values for this view. This record serves the purpose of proper financial reporting on the fixed assets and creation of the profit and loss statement of the company. The Fixed Asset business object 164 encompasses the definition of the view, the line items, totals in financial accounting, along with the recording of the results of changes in value due to depreciation, revaluation or interest, and the calculation parameters used for determining these values.

The Overhead Cost Ledger Account business object 166 represents a record of the costs incurred by the provision of resources. This record serves the purpose of proper financial reporting of the profit and loss statement of a company, and contains the costs that cannot be assigned directly to market segments.

The General Ledger Account business object 138 represents a record of valuation relevant quantities and values of a company related to a functional grouping item of a chart of accounts. This record serves the purposes of a company's proper financial reporting in accordance with a set of books.

The Accounts Receivable Payable Ledger Account business object 142 represents a record of valuated payables and receivables of a Company for a specific Business Partner. This record serves the purposes of proper financial reporting for these payables and receivables or of producing the company's profit and loss statement.

The Tax Ledger Account business object 144 records of valuated payables and receivables from sales tax and excise duty for a company concerning tax authorities and relating to a tax type and other tax characteristics. This record serves the purpose of proper financial reporting for sales tax and excise duty for a company.

As shown in FIG. 1B, the Accounting process component 118 also includes a Fixed Asset Depreciation Run mass data run object 168, an Inventory Price Change Run mass data run object 170, a Work in Process Clearing Run mass data run object 172, a Production Ledger Account Overhead Cost Calculation Run mass data run object 174, a Goods Receipt Invoice Receipt Clearing Run mass data run object 176, a Sales Ledger Account Overhead Cost Calculation Run mass data run object 178, a Sales Ledger Account Accruals Run mass data run object 180, a Balance Sheet and Income Statement Report business object 182, an Accounts Receivable Payable Ledger Account Regrouping Run mass data run object 184, a Balance Carry Forward Run mass data run object 186, an Accounting Document Report business object 188, an Accounting Document Report Run mass data run object 190, an Accounts Receivable Payable Ledger Account Foreign Currency Re-measurement Run mass data run object 192, a Cash Ledger Account Foreign Currency Re-measurement Run mass data run object 194, an Overhead Cost Assessment Run business object 196, an Account Balance Report business object 198, and an Overhead Cost Ledger Account Overhead Cost Calculation Run mass data run object 199.

The Fixed Asset Depreciation Run business object 168 represents the automatic posting of depreciations and asset values made to a number of fixed assets. The Fixed Asset Depreciation Run business object 168 can be started for a company and a Set of Books.

The Inventory Price Change Run business object 170 coordinates a change of material inventory price in a number of particular Material Ledger Accounts.

The Work in Process Clearing Run business object 172 coordinates an automatic periodic clearing of work in progress at the end of a period in a number of Production Ledger Accounts.

The Production Ledger Account Overhead Cost Calculation Run business object 174 represents an automatic run for calculating and posting overhead costs in a number of particular Production Ledger Accounts at the end of a period.

The Goods Receipt Invoice Receipt Clearing Run business object 176 represents the automatic determination of price variance between valuated goods receipts and invoice receipts in a number of particular purchase ledger accounts at the end of a period.

The Sales Ledger Account Overhead Cost Calculation Run business object 178 represents an automatic run for calculating and posting overhead costs in a number of particular Sales Ledger Accounts at the end of a period.

The Sales Ledger Account Accruals Run business object 180 represents an automatic valuation of business transactions of sales and distribution carried out on a number of particular Sales Ledger Accounts at the end of a period. This is done to obtain a period-based representation of the operating profit.

The Balance Sheet and Income Statement Report business object 182 represents a report that discloses the book value and net income of a business or other organization at a particular date, often at the end of its fiscal year, in a predefined format as stipulated by the legal authorities.

The Accounts Receivable Payable Ledger Account Regrouping Run business object 184 represents an automatic revaluation of foreign currency amounts (receivables and payables) in Financial Accounting that is carried out on a number of particular accounts receivable payable ledger accounts at the end of the period, depending on the set of books.

The Balance Carry Forward Run business object 186 represents an automatic carry forward of fiscal year balances to the next fiscal year in a number of particular General Ledger Accounts and Fixed Assets at the end of the fiscal year. The accounting principle, company, and target fiscal year are taken into account.

The Accounting Document Report business object 188 generates a report which discloses postings of the posting period in the context of accounting documents in a predefined format stipulated by legal authorities and displays the most important data from the accounting document header and line items together. The report can be delivered to the authorities.

The Accounting Document Report Run business object 190 is used to launch the Accounting Document Report in the background.

The Accounts Receivable Payable Ledger Account Foreign Currency Re-measurement Run business object 192 coordinates an automatic revaluation of foreign currency amounts (receivables and payables) in Financial Accounting that is carried out on a number of particular Accounts Receivable Payable Ledger Accounts at the end of the period, depending on the Set of Books.

The Cash Ledger Account Foreign Currency Re-measurement Run business object 194 coordinates an automatic revaluation of foreign currency amounts (cash) in Financial Accounting that is carried out on a number of particular Cash Ledger Accounts at the end of the period, depending on the Set of Books.

The Overhead Cost Assessment Run business object 196 represents the automatic rule-based allocation of values and quantities collected in a number of particular Overhead Cost Ledger Account objects using key figures or keys (headcount, usage areas or dynamically determinable bases). The Overhead Cost Assessment Run business process object 196 process is normally carried out at the end of a period.

The Account Balance Report business object 198 generates a report which discloses period totals from General Ledger Accounts (single account or accumulated amounts for a range of accounts) as the balance carried forward at the beginning of the fiscal year, total of the period or periods carried forward, debit total of the reporting period, credit total of the reporting period, debit or credit balances at the close of the reporting period in a predefined format stipulated by legal authorities.

The Overhead Cost Ledger Account Overhead Cost Calculation Run business object 199 coordinates an automatic run for calculating and posting overhead costs in a number of particular Overhead Cost Ledger Accounts at the end of a period.

As shown in FIG. 1C, the Accounting process component 118 also includes an Accounting Clearing Object History business object 131, an Other Direct Cost Ledger Account Overhead Cost Calculation Run business object 133, an Accounting Data Collection for Export Result business object 135, a Cash Flow Statement business object 137, an Accounting Statutory Report Run business object 139, an Accounting Entry Recurrence Definition business object 141, an Accounting Business Transaction Run business object 143, an Accounting Data Collection For Export Run business object 145, a Miscellaneous Subledger Account business object 147, a CN Golden Audit Report business object 149, an Accounting Processing Error business object 151, a Recurring Accounting Entry Run business object 153, and an Accounting Reconciliation Run business object 155.

The Accounting Clearing Object History business object 131 represents a chronological record of creation and clearing information relating to a clearing object in accounting.

The Other Direct Cost Ledger Account Overhead Cost Calculation Run business object 133 represents the specification of an automated run that calculates and posts overhead costs based on other direct cost ledger accounts.

The Accounting Data Collection for Export Result business object 135 represents a result of a collection of accounting data of a company for export.

The Cash Flow Statement business object 137 represents a statement of changes in cash and cash equivalents during a period, published in a predefined format as stipulated by the legal authorities.

The Accounting Statutory Report Run business object 139 represents a specification for, and the execution of, an automated run to create an accounting statutory report.

The Accounting Entry Recurrence Definition business object 141 represents a definition of the recurrence of an accounting entry. It can define how many accounting entries are generated based on a template accounting entry and at which points in time they are posted.

The Accounting Business Transaction Run business object 143 represents a specification, execution, and documentation of an automated run that performs non-standard business transactions in Accounting or adjustments in Accounting business objects.

The Accounting Data Collection For Export Run business object 145 represents a specification for, and the execution of, an automated run that collects accounting data for export based on accounting documents and business partners.

The Miscellaneous Subledger Account business object 147 represents a record for a company based on the principle of double-entry bookkeeping that shows the effects of miscellaneous, incidental business transactions in a subledger. The semantics of the content in the subledger can be defined by the accountant.

The CN Golden Audit Report business object 149 represents a collection of a predefined set of financial data in the format defined by the legal authorities for auditing purposes.

The Accounting Processing Error business object 151 represents an error situation detected by the system which prevents automatic processing in the Accounting process component 118 and which should be solved manually by the user responsible for an accounting department.

The Recurring Accounting Entry Run business object 153 represents a specification for an automatic run that posts accounting entries created as a result of an accounting entry recurrence definition.

The Accounting Reconciliation Run business object 155 represents a specification for an automated run that checks, documents and (if desired) restores object consistency in Financial Accounting based on business objects relevant for the balance sheet.

As shown in FIG. 1D, the Financials deployment unit 116 also includes a Financial Accounting Master Data Management process component 167. The Financial Accounting Master Data Management process component 167 includes a Service Product Valuation Data business object 169, a Material Valuation Data business object 171, a Resource Valuation Data business object 173, an Overhead Cost Scheme business object 175, a Financial Accounting View of Project business object 177, an Overhead Cost Assessment Rule business object 179, a Service Production Valuation Data Template business object 163, a Material Valuation Data Template 165, a Set of Books business object 181, a Financial Accounting View of Purchasing Document business object 183, a Financial Accounting View of Production Document business object 185, and a Financial Accounting View of Sales and Service Document business object 187.

The Service Product Valuation Data business object 169 represents internal prices for the valuation of business transactions related to a service product or a service product group and for cost estimation. These attributes and prices may depend on organizational units and other Financials or Financial Accounting entities such as a Set of Books or an accounting period.

The Material Valuation Data business object 171 represents internal prices for the valuation of business transactions related to a material or a material group, for material inventory valuation and for cost estimation. These attributes and prices may depend on organizational units, orders with reference to a material such as a sales order, production lot, project and other Financials or Financial Accounting entities.

The Resource Valuation Data business object 173 represents attributes and internal cost rates for the valuation of business transactions related to a resource and for cost estimation.

The Overhead Cost Scheme business object 175 represents a set of rules for the calculation of overhead charges. The rules can define the base data and the corresponding overhead rates.

The Financial Accounting View of Project business object 177 represents a Financial Accounting project and its structure.

The Overhead Cost Assessment Rule business object 179 specifies which costs are to be allocated, the receivers, and the assessment base to calculate the charges.

The Service Product Valuation Data Template business object 163 represents a collection of predefined values for attributes of a service product valuation data.

The Material Valuation Data Template business object 165 represents a collection of predefined values for attributes of a material valuation data.

The Set of Books business object 181 specifies the structuring of a body of accounting records containing data of positions of a balance sheet and profit and loss statement. The Set of Books business object 181 can include specifications for the chart of accounts, the fiscal year variant, the accounting principle, and the company currencies.

The Financial View of Purchasing Document business object 183 represents an accounting view of a document of production and its structure. It contains only those elements and characteristics of a production document that are relevant to accounting and costing.

The Financial Accounting View of Production Document business object 185 contains the accounting and costing relevant elements and characteristics of a production document. An example for a production document is the production lot.

The Financial Accounting View of Sales and Service Document business object 187 represents an accounting view of a legal sales agreement with a buyer party or a service agreement. A financial accounting view of sales document contains only the accounting and costing relevant elements and characteristics of a sales or service document.

As shown in FIG. 1E, the Financials deployment unit 116 also includes a Payment Processing process component 103 which handles the processing and management of all payments. The Payment Processing process component 103 can also be responsible for the associated communication with financial institutions, such as banks, and can provide the primary input for liquidity management. The Payment Processing process component 103 includes a Payment Order business object 101, an Incoming Check business object 127, a Bill of Exchange Storage business object 129, a Cash Storage business object 157, a House Bank Statement business object 159, an Outgoing Check business object 102, a Payment Card Payment Settlement Run business object 120, a Company Payment File Register business object 104, a Bill of Exchange Receivable business object 106, a Bill of Exchange Cashing business object 108, a Payment Register business object 110, a Clearing House Payment Order business object 112, a Check Deposit business object 132, a Bill of Exchange Deposit business object 134, a Bill of Exchange Payable business object 136, a Payment Media Run business object 114, a House Bank Account business object 197, a Bank Payment Order business object 140, a Check Storage business object 189, a Payment Advice business object 101A, a Cash Transfer business object 102A, a Payment Allocation business object 103A, and a Payment Media Deposit Creation Run business object 104A.

The Payment Order business object 101 represents an order within a company to initiate a payment transaction to or from a business partner at a specified time. A payment order can be a collective order that contains several individual orders.

The Incoming Check business object 127 represents a check issued by a business partner payable to the company.

The Bill of Exchange Storage business object 129 represents a company's location for bills of exchange receivable of one currency.

The Cash Storage business object 157 represents a company's location for cash of one currency.

The House Bank Statement business object 159 represents a legally binding notification from the house bank about the transactions within a specific time period at a house bank account with a defined starting and closing balance.

The Outgoing Check business object 102 represents a check issued by a company payable to a business partner to fulfill a payment order.

The Payment Card Payment Settlement Run business object 120 represents a specification for an automated run that creates settlement requests for clearing house payment orders to a clearing house based on clearing house payment orders.

The Company Payment File Register business object 104 represents a company's register for payment files that are exchanged with house banks.

The Bill of Exchange Receivable business object 106 represents a bill of exchange issued either by the company or by a business partner for the benefit of the company.

The Bill of Exchange Cashing business object 108 represents a cashing of bills of exchange payable at a house bank for debit from a house bank account.

The Payment Register business object 110 represents the register of incoming and outgoing payments of a company that can be initiated by the company as well as by a business partner.

The Clearing House Payment Order business object 112 represents an order to a clearing house for card payments to settle an incoming card payment using a clearing house account.

The Check Deposit business object 132 represents a deposit of checks at a bank for credit to a bank account.

The Bill of Exchange Deposit business object 134 represents a deposit of bills of exchange receivable at a house bank for credit to a house bank account.

The Bill of Exchange Payable business object 136 represents a bill of exchange for an outgoing payment.

The Payment Media Run business object 114 represents a specification for an automated run that creates payment media for bank transfers, debit memos, checks, and bills of exchange based on outgoing checks, bank payment orders, payment orders, bills of exchange receivable and payable.

The House Bank Account business object 197 represents an internal representation of a company's bank account at a bank. It can include all control information required for processing payments.

The Bank Payment Order business object 140 represents an order to a house bank to make a transfer or direct debit from a specified house bank account to fulfill a payment order.

The Check Storage business object 189 represents a location for incoming checks that a company receives from its business partners, such as customers.

The Payment Advice business object 101A represents an announcement of a payment transaction by a business partner to the company, specifying payment reasons.

The Cash Transfer business object 102A represents a company-internal money transfer that can include: payments from one house bank account to another (house bank account transfer), payments from one cash storage to another (cash transfer), payments from a cash storage to a house bank account (cash deposit), and payments from a house bank account to a cash storage (cash withdrawal).

The Payment Allocation business object 103A represents an assignment of a payment item to the payment reasons from which the payment item originated.

The Payment Media Deposit Creation Run business object 104A represents a specification for an automated run that creates payment media deposits to be submitted to a house bank based on bills of exchange receivable and incoming checks.

As shown in FIG. 1F, the Financials deployment unit 116 also includes a Due Item Processing process component 105. The Due Item Processing process component 105 can collect, manage, and monitor trade receivables or payables and corresponding sales tax or withholding tax. The Due Item Processing process component 105 includes a Withholding Tax Declaration business object 105A, a Trade Receivables Payables Register business object 106A, a Tax Receivables Payables Register business object 107A, a Trade Receivables Payables Account Statement Creation Run business object 108A, a Trade Receivables Payables Account Statement business object 109A, a Due Payment business object 110A, a European Community Sales List Report business object 111A, a Tax Due Payment business object 112A, a Trade Receivables Payables Account business object 113A, a Receivables Payables Entry business object 114A, a Due Clearing business object 115A, a Dunning Run business object 116A, a Tax Declaration Run business object 117A, a Dunning business object 118A, a Due Payment Run business object 119A, and a Product Tax Declaration business object 120A.

The Withholding Tax Declaration business object 105A represents a declaration of withholding tax payables of a company to a tax authority according to the tax declaration arrangement and country specific legal requirements that triggers the payment to the tax authority if required.

The Trade Receivables Payables Register business object 106A represents the register of all trade receivables and payables of a company from or to its business partners.

The Tax Receivables Payables Register business object 107A represents the register of tax receivables and payables of a company for delivered goods and rendered services between buyers and sellers, the consumption of goods, the transfer of goods, and amounts withheld from payments to sellers.

The Trade Receivables Payables Account Statement Creation Run business object 108A represents a specification of an automated run that creates account statements for trade receivables and payables based on trade receivables and payables accounts.

The Trade Receivables Payables Account Statement business object 109A represents a list of the increases or decreases to trade receivables or payables of a company from or to a business partner within a certain time period.

The Due Payment business object 110A represents a payment request or a payment confirmation for trade receivables and payables.

The European Community Sales List Report business object 111A represents a declaration of the statistical value added tax (VAT) tax payables/receivables of a European Union (EU) member state company to a tax authority according to the tax declaration arrangement and country specific legal requirements.

The Tax Due Payment business object 112A represents a payment request or payment confirmation with regard to tax payables and receivables.

The Trade Receivables Payables Account business object 113A represents an account of all trade receivables and payables of a company from or to a business partner. It also can include guidelines and agreements concerning the payments and dunning of receivables and payables for a business partner.

The Receivables Payables Entry business object 114A represents a business transaction either for the creation of a payable or receivable or for an adjustment of the tax reporting of a company.

The Due Clearing business object 115A represents a group of receivables and payables for clearing.

The Dunning Run business object 116A represents a specification of an automated run that creates dunning proposals based on trade receivables and payables accounts.

The Tax Declaration Run business object 117A represents a specification of an automated run that creates tax declarations (e.g., a product tax declaration or a European Community sales list report) based on a selection of Tax Receivable/Payable Split Items.

The Dunning business object 118A represents a reminder or demand from a company (creditor) to a business partner (debtor) to make a payment by a certain point in time.

The Due Payment Run business object 119A represents a specification of an automated run that creates payment requests based on due trade receivables and payables.

The Product Tax Declaration business object 120A represents a declaration of the product tax payables/receivables of a company to the responsible tax authority according to the tax declaration arrangement and country specific legal requirements that triggers the payment to the tax authority if required.

As shown in FIG. 1G, the Financials deployment unit 116 also includes a Migration Data Dispatching process component 107, a Balance of Foreign Payment Management process component 109, a Costing process component 111, and a Cash Management process component 113. The Migration Data Dispatching process component 107 processes data that must be migrated to more than one deployment unit and that must be kept consistent across the deployment units. The processing of this data is a one-off activity that occurs before go-live. The Balance of Foreign Payment Management process component 109 handles the collection, processing, and reporting of receivables and payables according to foreign trade regulations that are required by the financial authority of a country, such as the central bank. The Costing process component 111 estimates costs for objects such as materials, projects, service products, sales order items, or production lots. The Cash Management process component 113 handles the analysis and management of current and future liquidity.

The Migration Data Dispatching process component 107 includes a Receivables Payables Migration List business object 121A and a Payment Migration List business object 122A. The Receivables Payables Migration List business object 121A represents a list of open receivables or payables of a company that have to be migrated to a new system. The Payment Migration List business object 122A represents a list of payments of a company that have to be migrated to a new system.

The Balance of Foreign Payment Management process component 109 includes a Foreign Receivable Payable business object 123A. The Foreign Receivable Payable business object 123A represents a receivable from, or a payable to, a non-resident business partner.

The Costing process component 111 includes a Project Cost Estimate business object 124A. The Project Cost Estimate business object 124A represents a statement of the costs that are calculated for carrying out a project. It includes both an overall result of the cost estimate and details of individual cost items. The cost items can be derived from material input, resource input, external/internal services, and costs relating to a trip.

The Cash Management process component 113 includes a Liquidity Forecast Creation Run business object 125A, a Liquidity Forecast business object 126A, and an Expected Liquidity Item business object 127A. The Liquidity Forecast Creation Run business object 125A represents a specification of an automated run that creates a liquidity forecast based on the trade receivables payables register, tax receivables payables register, payment register, and expected liquidity items. The Liquidity Forecast business object 126A represents a preview of the medium- to long-term development of the liquidity situation of a company or a group of companies. The Expected Liquidity Item business object 127A represents an expected single amount that increases or reduces the liquidity of a company.

As shown in FIG. 1H, a Foundation deployment unit 117 includes a Financial Market Data Management process component 191, an Organizational Management process component 119, a Cash Flow Management Foundation process component 121, and an Accounting Coding Block Distribution Processing process component 123. The Financial Market Data Management process component 191 manages financial accounting master data that is used both for accounting and costing purposes. The Cash Flow Management Foundation process component 121 manages foundation objects used within cash flow management. Cash flow management can comprise process components Due Item Processing, Payment Processing, and Cash Management. The Organizational Management process component manages the provision of central and unified organizational structures of the enterprise and its collaborative partners. The Accounting Coding Block Distribution Processing process component 123 manages the registration and checking of all accounting objects that can be assigned in a source document for a business transaction, such as cost center, project, or market segment. For example, the process component can dispatch a check request to the deployment unit of the accounting object.

The Financial Market Data Management process component 191 includes an Exchange Rate business object 193 and a Bank Directory Entry business object 195. The Exchange Rate business object 193 represents a relative value of two different currencies for a time span. It is used to convert from one currency to another. Exchange rates can be specified by exchange rate type (e.g., bid/mid/ask). The Bank Directory Entry business object 195 represents an entry with the main information on a bank in a classified directory of banks.

The Organizational Management process component 119 includes a Company Financials Process Control business object 128A, a Cost Center business object 128B, a Company business object 128C, a Segment business object 128D and a Profit Center business object 128E. The Company Financials Process Control business object 128A represents information about a company that is required to control financial processes. The Cost Center business object 128B represents an organizational center where costs are incurred and for which costs are recorded separately. The Company business object 128C represents a financially and legally-independent organizational center that is not tied to a geographical location and that is registered under business law. The Segment business object 128D represents an organizational center that represents a corporate division for which financial information has to be published. In some implementations, organizational center's business activities can result in revenue and expenditure, and the operating income can be regularly monitored by the main decision-makers for the purpose of assigning resources and evaluating performance. The Profit Center business object 128E represents an organizational center that represents an area of a company for which a separate period-based profit is determined and used for profit-oriented analysis and management of the area's activities.

The Cash Flow Management Foundation process component 121 includes a Financial Audit Trail Documentation business object 124, and a Cash Flow Expense and Receipt Explanation business object 124B. The Financial Audit Trail Documentation business object 124 represents a uniform documentation of the changes to receivables and payables and financial transactions linked to a business transaction for audit purposes. The Cash Flow Expense and Receipt Explanation business object 124B represents an explanation of an expense or receipt of financial assets within the cash flow management process components that can include the Due Item Processing process component 105 and the Payment Processing process component 103.

The Accounting Coding Block Distribution Processing process component 123 includes an Accounting Coding Block Distribution business object 130, and a Market Segment business object 130A. The Accounting Coding Block Distribution business object 130 represents the distribution of coding blocks to enterprise resources changes, such as expenses or material movements. For example, a coding block is a set of accounting objects to which an enterprise resource change is assigned. The resource change is ultimately valued in accounting. The Market Segment business object 130A represents a sector of the overall market that is characterized by a particular supply and demand situation and that exhibits specific customer and product characteristics as well as characteristics for regional and organizational classification.

As shown in FIG. 1I, the Foundation deployment unit 117 includes a Payment Master Data Management process component 125, and a Business Partner Data Management process component 115. The Payment Master Data Management process component 125 manages payment master data, such as clearing house accounts, that is used in different business areas. In some implementations, it also contains views of house bank accounts and cash storages. The Business Partner Data Management process component 115 manages all the business partner master data of a company. In some implementations, this data can contain the information needed to describe the rights and obligations of a business partner participating in various business processes, such as sales, purchasing, and accounting processes.

The Business Partner Data Management process component 115 includes a Cash Discount Terms business object 128, a Payment Agreement business object 126B, a Tax Authority business object 126C, a House Bank business object 126D, a Company Tax Arrangement business object 126E and a Clearing House business object 126F. The Cash Discount Terms business object 128 represents a collection of modalities agreed on by business partners for the payment of goods delivered or services provided. These modalities can consist of incremental payment periods and the deductions that are allowed when payment is made within one of these periods. The Payment Agreement business object 126B represents an agreement between a company and a business partner on the handling of payments. For example, it defines the payment methods allowed and which bank details or credit cards should be used. The Tax Authority business object 126C represents an authority that collects and administers taxes. The House Bank business object 126D represents an organization that provides banking services for the company, such as account management or lockbox. The Company Tax Arrangement business object 126E represents an agreement between a company and a tax authority regarding the declaration and payment of taxes. The Clearing House business object 126F represents an organization that provides services for the settlement of payment card payments, such as the authorization of payments.

The Payment Master Data Management process component 125 includes a Payment Control business object 126, a Payment Explanation business object 122, a Core View Of House Bank Account business object 122B, a Clearing House Account business object 122C, and a Core View Of Cash Storage business object 122D. The Payment Control business object 126 represents an agreement between a company and a business partner on processing payments for an individual business transaction. The Payment Explanation business object 122 represents a reason or reasons for a payment, typically with reference to one or more business documents, such as contracts, invoices, credit memos, or sales orders. The Core View Of House Bank Account business object 122B represents a view of a house bank account that contains identification, type, and currency data. The Clearing House Account business object 122C represents a company-internal representation of an account that is set up and managed at a clearing house for card payments for the company. In some implementations, it is based on an agreement between the company and the clearing house. The Core View Of Cash Storage business object 122D represents a view of a cash storage that contains identification and currency data.

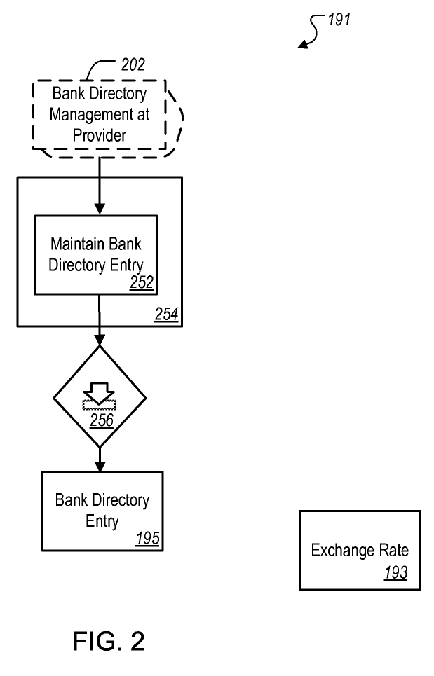

FIG. 2 is a block diagram showing the Financial Market Data Management process component 191 (FIG. 1H). The Financial Market Data Management process component 191 handles the management of financial market data. This data can be obtained from generally accepted external providers. For convenience in describing this process component, a Bank Directory Management at Provider process component 202 is shown in the figure; this other process component is not part of the process component being described. The Bank Directory Management at Provider process component 202 is used to represent software external to the Financial Market Data Management process component 191 in describing its interactions with the external software. This process component is drawn with dashed lines to indicate that it is used to represent an external system in describing interactions with the external system; this should be understood to require no more of the external system than that it be able to produce and receive messages as required by the process component that interacts with the external system. However, while the external software can be implemented as such process components, this is not required.

As shown in FIG. 2, the Exchange Rate business object 193 is included in the Financial Market Data Management process component 191, but is not shown in the interactions.

A Maintain Bank Directory Entry operation 252 is included in a Bank Directory Transmission In interface 254. The Maintain Bank Directory Entry operation 252 receives a bank transmission from an instance of the Bank Directory Management at Provider process component 202 to create, change, or delete bank directory entries. A Maintain Bank Directory Entry asynchronous outbound process agent 256 receives information from the operation 252 and updates the Bank Directory Entry business object 195.

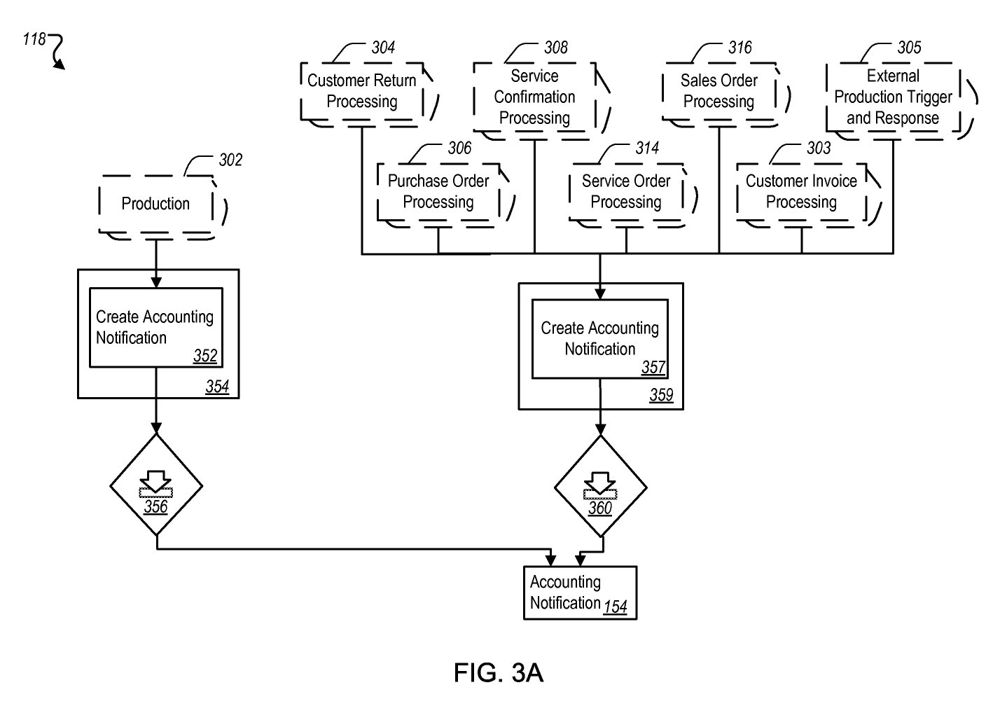

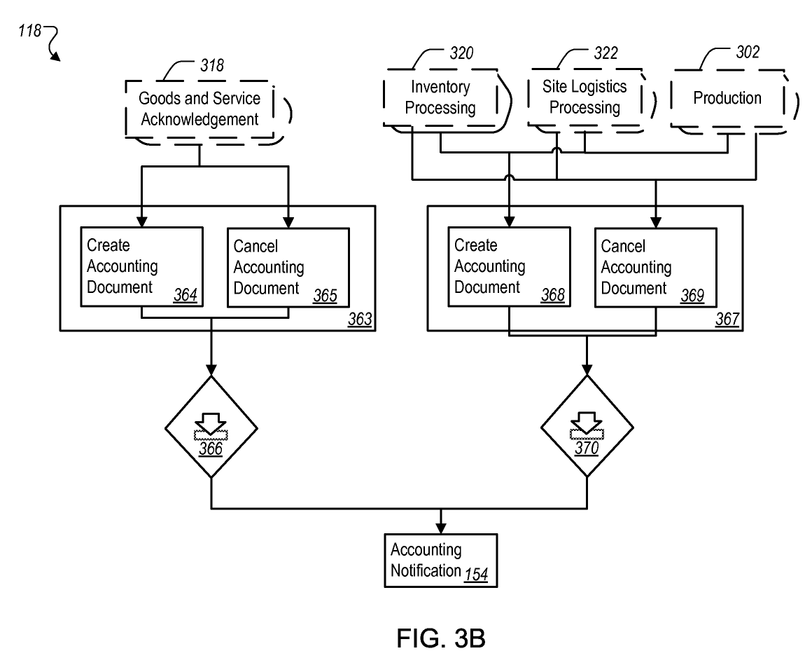

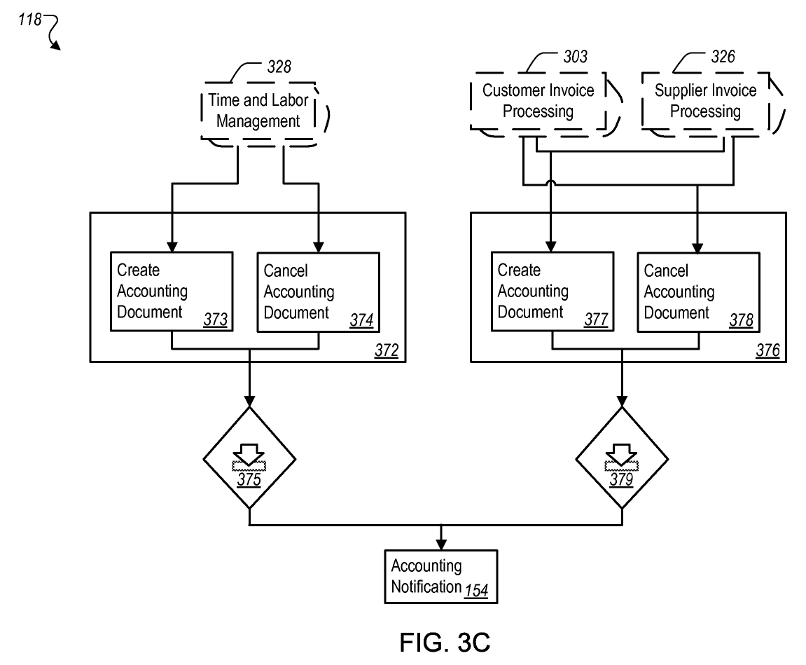

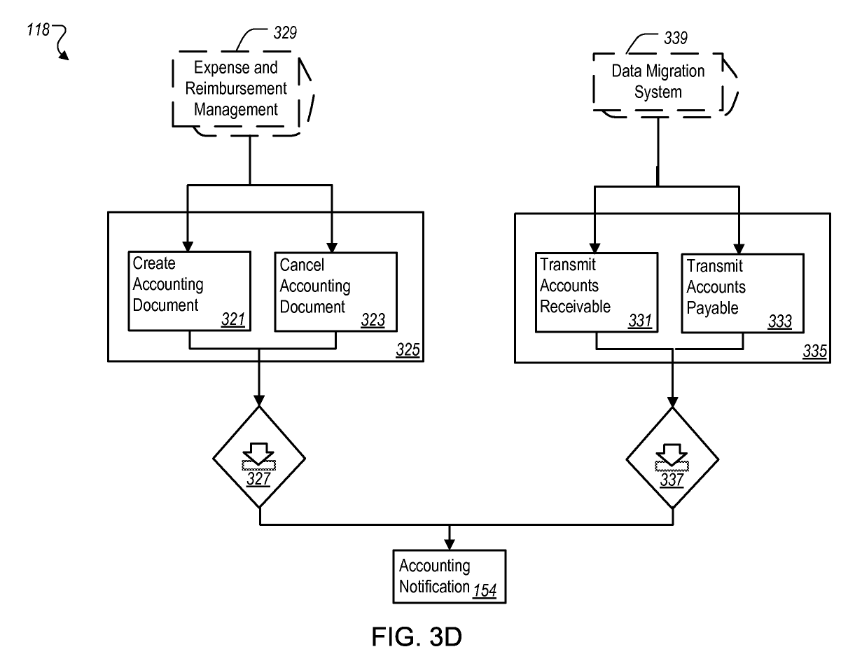

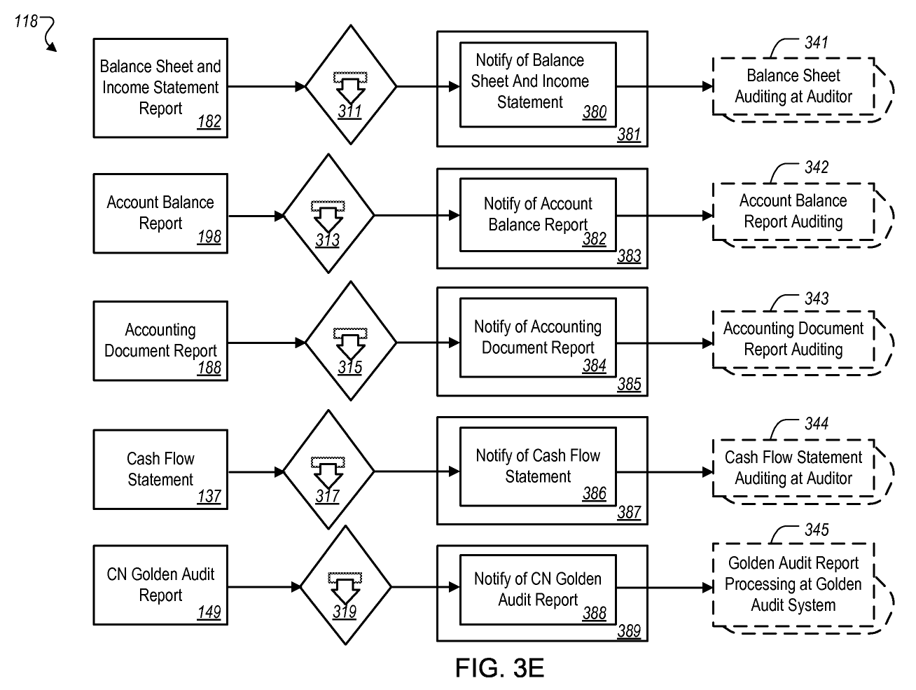

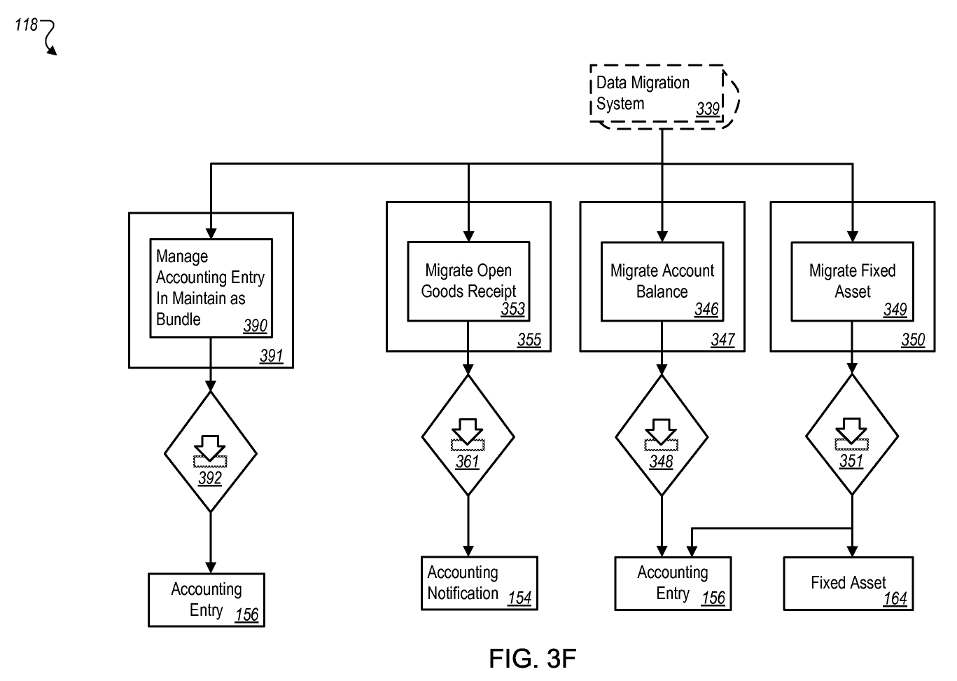

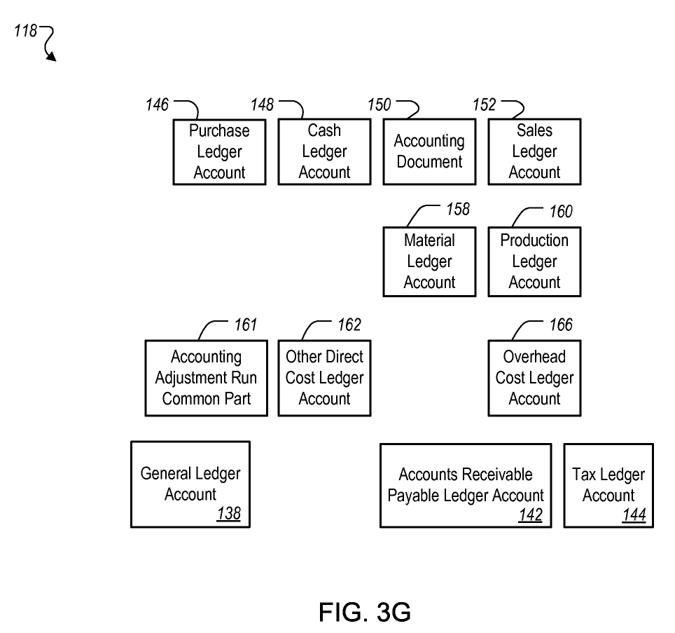

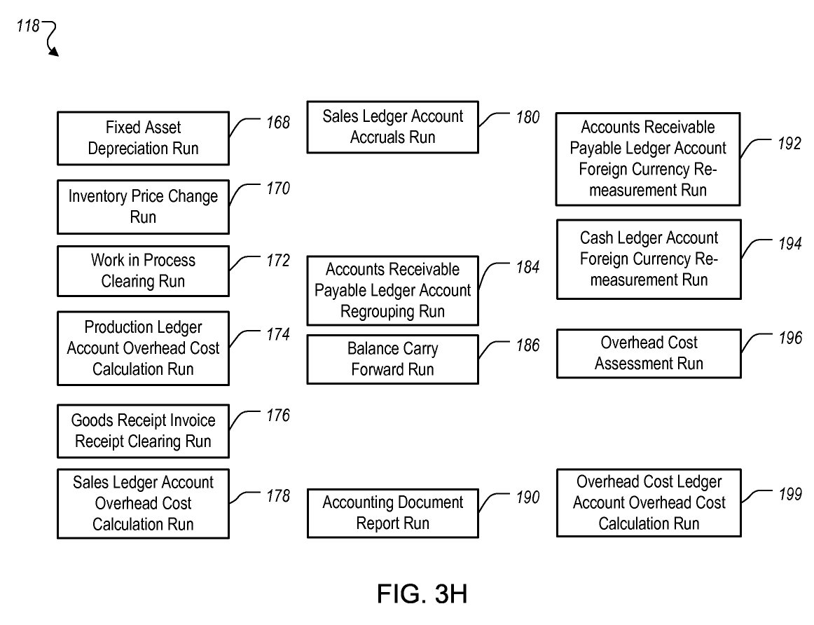

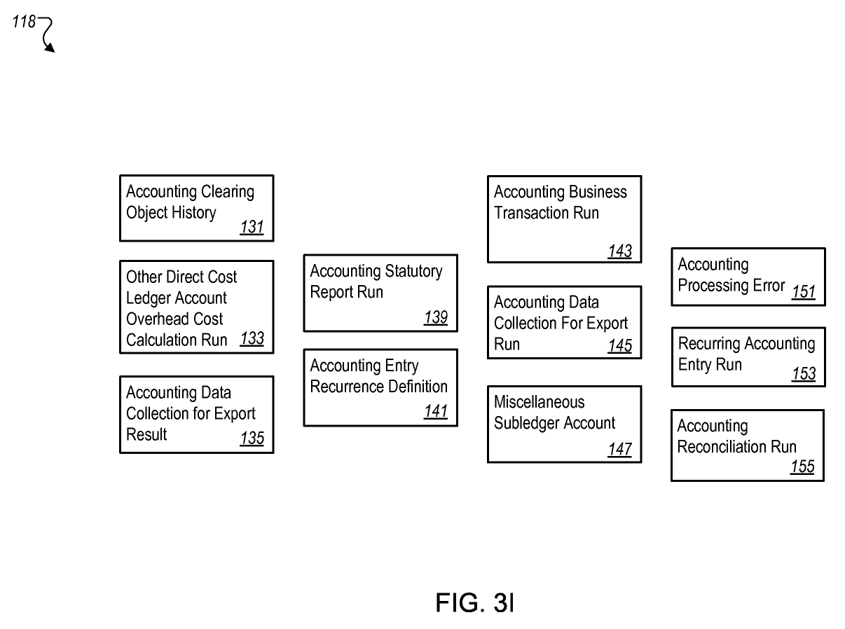

FIGS. 3A, 3B, 3C, 3D, 3E, 3F, 3G, 3H and 3I are block diagrams collectively showing the Accounting process component 118 (FIG. 1A). The Accounting process component 118 represents all relevant business transactions for valuation and profitability analysis. For convenience in describing this process component, a number of external process components are shown in the figures; these other process components are not part of the process components being described. These other process components are a Production process component 302, a Customer Return Processing process component 304, a Purchase Order Processing process component 306, a Service Confirmation Processing process component 308, a Service Order Processing process component 314, a Sales Order Processing process component 316, a Customer Invoice Processing process component 303, an External Production Trigger and Response process component 305, a Goods and Service Acknowledgement process component 318, an Inventory Processing process component 320, a Site Logistics Processing process component 322, a Supplier Invoice Processing process component 326, a Time and Labor Management process component 328, an Expense and Reimbursement Management process component 329, a Data Migration System process component 339, a Balance Sheet Auditing at Auditor process component 341, an Account Balance Report Auditing process component 342, an Accounting Document Report Auditing process component 343, a Cash Flow Statement Auditing at Auditor process component 344, and a Golden Audit Report Processing at Golden Audit System process component 345. These other process components represent software external to the process component in describing its interactions with the external software; however, while the external software can be implemented as such process components, this is not required.

As shown in FIG. 3A, a Create Accounting Notification operation 352 is included in a Production Accounting In interface 354. The Create Accounting Notification operation 352 receives notifications about the creation, change or deletion of production orders from an instance of the Production process component 302. The Production process component 302 handles execution of production on the shop floor. This includes the preparation, execution, confirmation, and completion as well as the more general functions such as scheduling, and monitoring. A Maintain Production Ledger Account asynchronous outbound process agent 356 receives information from the operation 352 and updates the Accounting Notification business object 154.

Several external process components provide input to a Create Accounting Notification operation 357 included in a Sales and Purchasing In interface 359. These include the Purchase Order Processing process component 306, the Customer Return Processing process component 304, the Service Confirmation Processing process component 308, the Service Order Processing process component 314, the Sales Order Processing process component 316, the Customer Invoice Processing process component 303, and the External Production Trigger and Response process component 305.

The Purchase Order Processing process component 306 handles the creation and maintenance of purchase orders and purchase order confirmations. The Customer Return Processing process component 304 processes requests made by customers to the seller to take back goods that were delivered, and to reverse the sale. The Service Confirmation Processing process component 308 reports back actual times and quantities for services provided and spare parts consumed related to the execution of a service order. The Service Order Processing process component 314 handles the creation, planning, and fulfillment of service orders. The Sales Order Processing process component 316 processes customers' requests to seller for the delivery of goods, on a specific date, for a specific quantity, and for a specific price. The Customer Invoice Processing process component 303 handles the invoicing of customers for the delivery of goods or the provision of services. The External Production Trigger and Response process component 305 manages of all the tasks necessary for processing procurement planning and procurement release orders, and provides the interface to purchasing, accounting, supplier invoicing, outbound delivery, and the supplier from a supply planning and control perspective.

The Create Accounting Notification operation 357 uses a Maintain Subledger Account Based on Sales and Purchasing asynchronous inbound process agent 360 to update the Accounting Notification business object 154.

As shown in FIG. 3B, a Goods and Service Accounting In interface 363 includes a Create Accounting Document operation 364 and a Cancel Accounting Document operation 365. The Create Accounting Document operation 364 creates an accounting document based on goods movement or resource consumption notifications from the Goods and Service Acknowledgement process component 318. The received data is first converted into an accounting notification from which one or more accounting documents are created according to the relevant sets of books. The Cancel Accounting Document operation 365 receives goods movement or resource consumption cancellation requests from the Goods and Service Acknowledgement process component 318. Both operations 364 and 365 use a Maintain Accounting Document Based on Goods and Service Acknowledgement asynchronous inbound process agent 366 to update the Accounting Notification business object 154.

An Inventory and Activity Accounting In interface 367 includes a Create Accounting Document operation 368 and a Cancel Accounting Document operation 369. The Create Accounting Document operation 368 receives inventory change accounting notifications from the Inventory Processing process component 320, the Site Logistics Processing process component 322, and/or the Production process component 302. The Cancel Accounting Document operation 369 receives inventory change accounting cancellation requests from the Inventory Processing process component 320, the Site Logistics Processing process component 322, or the Production process component 302. Both operations 368 and 369 use a Maintain Accounting Document Based on Inventory and Activity asynchronous inbound process agent 370 to update the Accounting Notification business object 154.

As shown in FIG. 3C, a Service Provision Accounting In interface 372 includes a Create Accounting Document operation 373 and a Cancel Accounting Document operation 374. The Create Accounting Document operation 373 receives resource consumption notifications from the Time and Labor Management process component 328. The Cancel Accounting Document operation 374 receives resource consumption cancellation requests from the Time and Labor Management process component 328. Both operations 373 and 374 use a Maintain Accounting Document Based on Service Provision asynchronous inbound process agent 375 to update the Accounting Notification business object 154.

An Invoice Accounting In interface 376 includes a Create Accounting Document operation 377 and a Cancel Accounting Document operation 378. The Create Accounting Document operation 377 creates an accounting document for a customer invoice or a supplier invoice using invoice information received from the Customer Invoice Processing process component 303 or the Supplier Invoice Processing process component 326. The accounting document records payables, receivables, expenses and revenues for the invoice in Financial Accounting. The Cancel Accounting Document operation 378 receives Invoice Accounting cancellation requests from the Customer Invoice Processing process component 303 or the Supplier Invoice Processing process component 326. Both operations 377 and 378 use a Maintain Accounting Document Based on Invoice asynchronous inbound process agent 379 to update the Accounting Notification business object 154.

As shown in FIG. 3D, an Expense Accounting In interface 325 includes a Create Accounting Document operation 321 and a Cancel Accounting Document operation 323. The Create Accounting Document operation 321 creates an accounting document based on expense data received from the Expense and Reimbursement Management process component 329. The received data is first converted into an accounting notification from which one or more accounting documents are created according to the relevant sets of books. The Cancel Accounting Document operation 323 receives cancellation requests from the Expense and Reimbursement Management process component 329. Both operations 321 and 323 use a Maintain Accounting Document Based on Expense asynchronous inbound process agent 327 to update the Accounting Notification business object 154.

An Accounts Receivable Payable Ledger Account Transmission In interface 335 includes a Transmit Accounts Receivable operation 331 and a Transmit Accounts Payable operation 333. The Transmit Accounts Receivable operation 331 transmits master data parts of accounts receivable ledger accounts from the Data Migration System process component 339 to accounting. The Transmit Accounts Payable operation 333 transmits master data parts of accounts payable ledger accounts from the Data Migration System process component 339 to accounting. Both operations 331 and 333 use a Migrate Accounting Document Based on Open Goods Receipt asynchronous inbound process agent 337 to update the Accounting Notification business object 154.

As shown in FIG. 3E, the Balance Sheet and Income Statement Report business object 182 uses a Create Form Balance Sheet outbound process agent 311 to invoke a Notify of Balance Sheet and Income Statement operation 380. The Notify of Balance Sheet and Income Statement operation 380 notifies the Balance Sheet Auditing at Auditor process component 341 of a balance sheet and income statement by an external employee. The operation 380 is included in a Balance Sheet and Income Statement Out interface 381.

The Account Balance Report business object 198 uses a Create Form Account Balance Report outbound process agent 313 to invoke a Notify of Account Balance Report operation 382. The Notify of Account Balance Report operation 382 notifies the Account Balance Report Auditing process component 342 of an account balance report. The operation 382 is included in an Account Balance Report Out interface 383.

The Accounting Document Report business object 188 uses a Create Form Accounting Document Report outbound process agent 315 to invoke a Notify of Accounting Document Report operation 384. The Notify of Accounting Document Report operation 384 notifies the Accounting Document Report Auditing process component 343 of an accounting document report. The operation 384 is included in an Accounting Document Report Out interface 385.

The Cash Flow Statement business object 137 uses a Create Form Cash Flow Statement outbound process agent 317 to invoke a Notify of Cash Flow Statement operation 386. The Notify of Cash Flow Statement operation 386 notifies the Cash Flow Statement Auditing at Auditor process component 344 of a cash flow statement. The operation 386 is included in a Cash Flow Statement Out interface 387.

The CN Golden Audit Report business object 149 uses a Notify of CN Golden Audit Report to Golden Audit System outbound process agent 319 to invoke a Notify of CN Golden Audit Report operation 388. The Notify of CN Golden Audit Report operation 388 notifies the Golden Audit Report Processing at Golden Audit System process component 345 of a CN Golden Audit Report. The operation 388 is included in a CN Golden Audit Report Out interface 389.

As shown in FIG. 3F, the Data Migration System process component 339 invokes a Migrate Open Goods Receipt operation 353 to convert information about open outgoing checks which are to be migrated from a legacy system into a payment migration list to forward this information to payment processing and accounting. The operation 353 is included in an Open Goods Receipt Migration In interface 355. The operation 353 uses a Migrate Open Goods inbound process agent 361 to update the Accounting Notification business object 154.

The Data Migration System process component 339 also invokes a Migrate Account Balance operation 346 to convert information about balances of a general ledger which are to be migrated from a legacy system to a new resource planning system into an accounting entry. The operation 346 is based on message type Accounting Account Balance Migrate Request Message (derived from the Accounting Entry business object 156). The operation 346 is included in an Account Balance Migration In interface 347. The operation 346 uses a Migrate Account Balance inbound process agent 348 to update the Accounting Entry business object 156. The process agent 348 migrates account balances from a source system to a target system.

The Data Migration System process component 339 also invokes a Migrate Fixed Asset operation 349 to convert information about fixed assets which are to be migrated from a legacy system to a new resource planning system into a fixed assent entry. The operation 349 is based on message type Accounting Fixed Asset Migrate Request Message (derived from the Fixed Asset business object 164). The operation 349 is included in a Fixed Asset Migration In interface 350. The operation 349 uses a Migrate Fixed Asset inbound process agent 351 to update the Fixed Asset business object 164. The process agent 351 performs all required steps related to fixed asset data migration. This includes master data creation, individual material assignment, and creation of postings (opening balance, current year transactions, and depreciation postings).

The Data Migration System process component 339 invokes a Manage Accounting Entry In Maintain as Bundle operation 390 to create and process accounting entries in a system, using accounting entries from a source file. The operation 390 is included in a Manage Accounting Entry In interface 391. The Manage Accounting Entry In Maintain as Bundle operation 390 uses a Manage Accounting Entry In inbound process agent 392 to update the Accounting Entry business object 156.

As shown in FIGS. 3G, 3H and 3I, several business objects are included in the Accounting process component 118, but are not shown in the interactions. As shown in FIG. 3G, these business objects include the Purchase Ledger Account business object 146, the Cash Ledger Account business object 148, the Accounting Document business object 150, the Sales Ledger Account business object 152, the Material Ledger Account business object 158, the Production Ledger Account business object 160, the Accounting Adjustment Run Common Part business object 161, the Other Direct Cost Ledger Account business object 162, the Overhead Cost Ledger Account business object 166, the General Ledger Account business object 138, the Accounts Receivable Payable Ledger Account business object 142, and the Tax Ledger Account business object 144.

As shown in FIG. 3H, business objects not included in the interactions of the Accounting process component 118 also include the Fixed Asset Depreciation Run mass data run object 168, the Inventory Price Change Run mass data run object 170, the Work in Process Clearing Run mass data run object 172, the Production Ledger Account Overhead Cost Calculation Run mass data run object 174, the Goods Receipt Invoice Receipt Clearing Run mass data run object 176, the Sales Ledger Account Overhead Cost Calculation Run mass data run object 178, the Sales Ledger Account Accruals Run mass data run object 180, the Accounts Receivable Payable Ledger Account Regrouping Run mass data run object 184, the Balance Carry Forward Run mass data run object 186, the Accounting Document Report Run mass data run object 190, the Accounts Receivable Payable Ledger Account Foreign Currency Re-measurement Run mass data run object 192, the Cash Ledger Account Foreign Currency Re-measurement Run mass data run object 194, the Overhead Cost Assessment Run business object 196, and the Overhead Cost Ledger Account Overhead Cost Calculation Run mass data run object 199.

As shown in FIG. 3H, business objects not included in the interactions of the Accounting process component 118 also include the Accounting Clearing Object History business object 131, the Other Direct Cost Ledger Account Overhead Cost Calculation Run business object 133, the Accounting Data Collection for Export Result business object 135, the Accounting Statutory Report Run business object 139, the Accounting Entry Recurrence Definition business object 141, the Accounting Business Transaction Run business object 143, the Accounting Data Collection For Export Run business object 145, the Miscellaneous Subledger Account business object 147, the Accounting Processing Error business object 151, the Recurring Accounting Entry Run business object 153, and the Accounting Reconciliation Run business object 155.

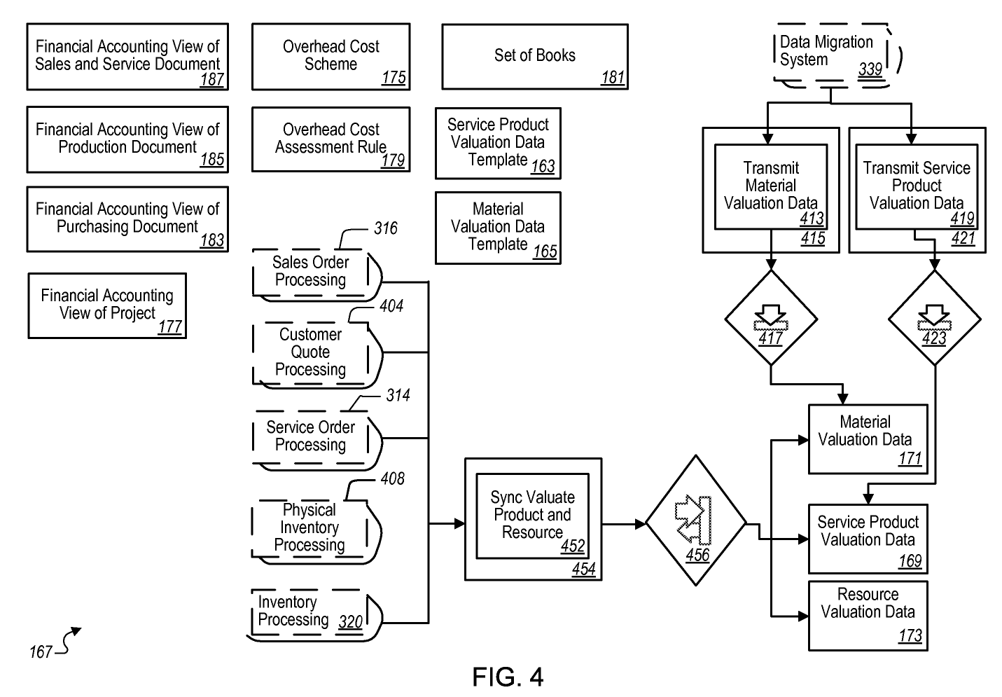

FIG. 4 is a block diagram of the Financial Accounting Master Data Management process component 167 (FIG. 1D). For convenience in describing this process component, a number of external process components are shown in the figures; these other process components are not part of the process components being described. These other process components are the Sales Order Processing process component 316, a Customer Quote Processing process component 404, the Service Order Processing process component 314, a Physical Inventory Processing process component 408, the Inventory Processing process component 320, and the Data Migration System process component 339.

The Customer Quote Processing process component 404 processes quotes to customers offering the delivery of goods or services according to specific terms. The Physical Inventory Processing process component 408 processes physical inventory for the purpose of executing a physical inventory count. The Inventory Processing process component 320 processes inventory for valuation purposes only. These other process components are used to represent software external to the process component in describing its interactions with the external software; however, while the external software can be implemented as such process components, this is not required. As shown in FIG. 4, several business objects are included in the Financial Accounting Master Data Management process component 167, but are not shown in the interactions. These include the Set of Books business object 181; the Financial Accounting View of Sales and Service Document business object 187; the Overhead Cost Scheme business object 175; the Financial Accounting View of Production Document business object 185; the Overhead Cost Assessment Rule business object 179; the Financial Accounting View of Purchasing Document business object 183; the Financial Accounting View of Project business object 177, the Service Product Valuation Data Template 163, and the Material Valuation Data Template 165.

As shown in FIG. 4, several process components may give input to the Synchronous Valuate Product and Resource operation 452. These include the Sales Order Processing process component 316, the Customer Quote Processing process component 404, the Service Order Processing process component 314, the Physical Inventory Processing process component 408, the Inventory Processing process component 320, and the Data Migration System process component 339. The Synchronous Valuate Product and Resource operation 452 is included in a Product and Resource Valuation In interface 454.

The Synchronous Valuate Product and Resource operation 452 can provide synchronous access to product price information. The operation 452 can invoke a Synchronous Valuate Product and Resource outbound process agent 456 to update the Material Valuation Data business object 171, the Service Product Valuation Data business object 169, and the Resource Valuation Data business object 173.

The Data Migration System process component 339 invokes a Transmit Material Valuation Data operation 413 to transmit information about material valuation data from the Data Migration System process component 339 into material valuation data and forwards this information to the Financial Accounting Master Data Management process component 167. The operation 413 is based on the message type Material Valuation Data Transmit Request (derived from the Material Valuation Data business object 171). The operation 413 is included in a Material Valuation Data Transmission In interface 415. The operation 413 uses a Transmit Material Valuation Data inbound process agent 417 to update the Material Valuation Data business object 171.

The Data Migration System process component 339 invokes a Transmit Service Product Valuation Data operation 419 to transmit information about service product valuation data from the Data Migration System process component 339 into service product valuation data and forwards this information to the Financial Accounting Master Data Management process component 167. The operation 419 is based on the message type Service Product Valuation Data Transmit Request (derived from the Service Product Valuation Data business object 169). The operation 419 is included in a Service Product Valuation Data Transmission In interface 421. The operation 419 uses a Transmit Service Product Valuation Data inbound process agent 423 to update the Service Product Valuation Data business object 169.

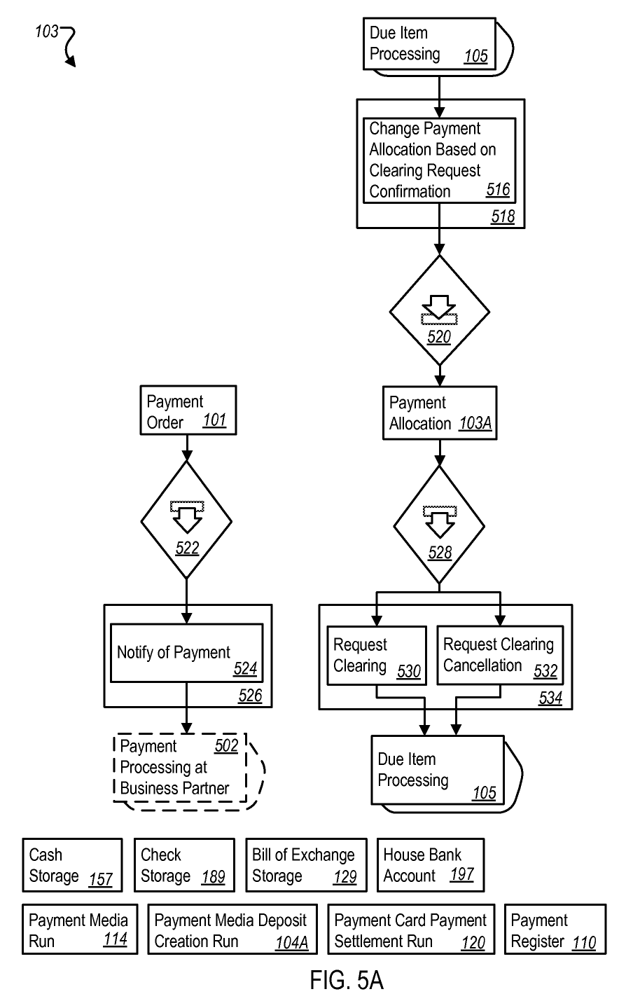

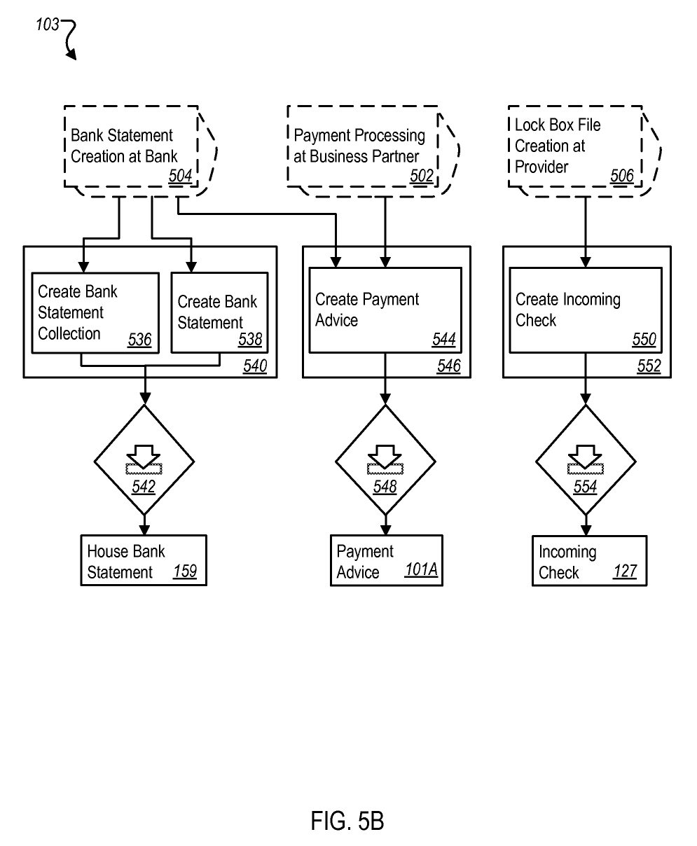

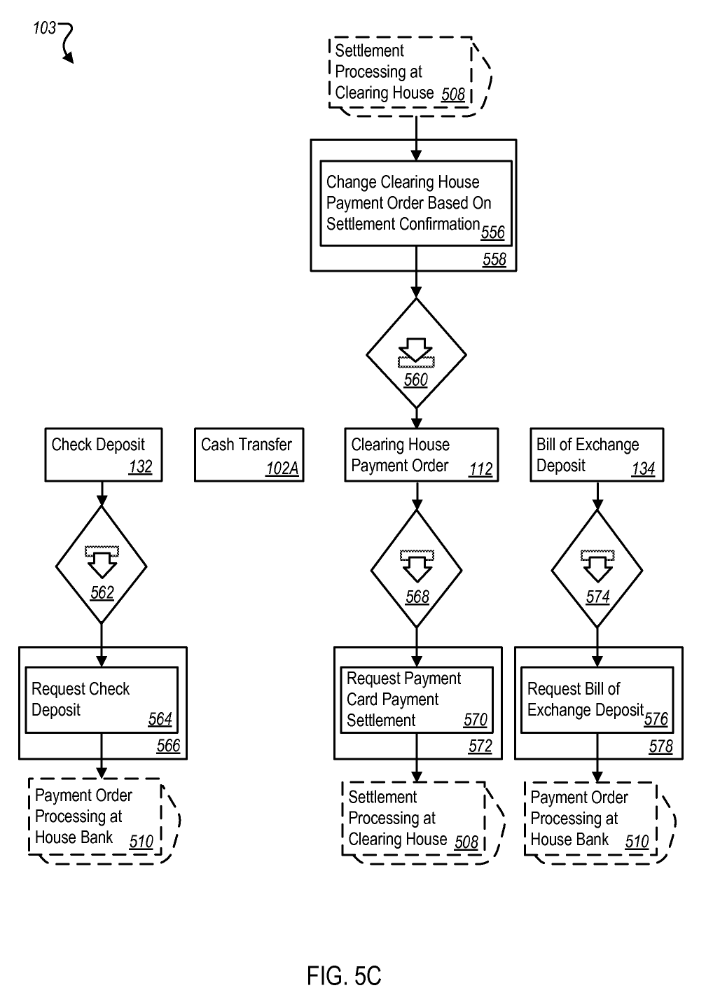

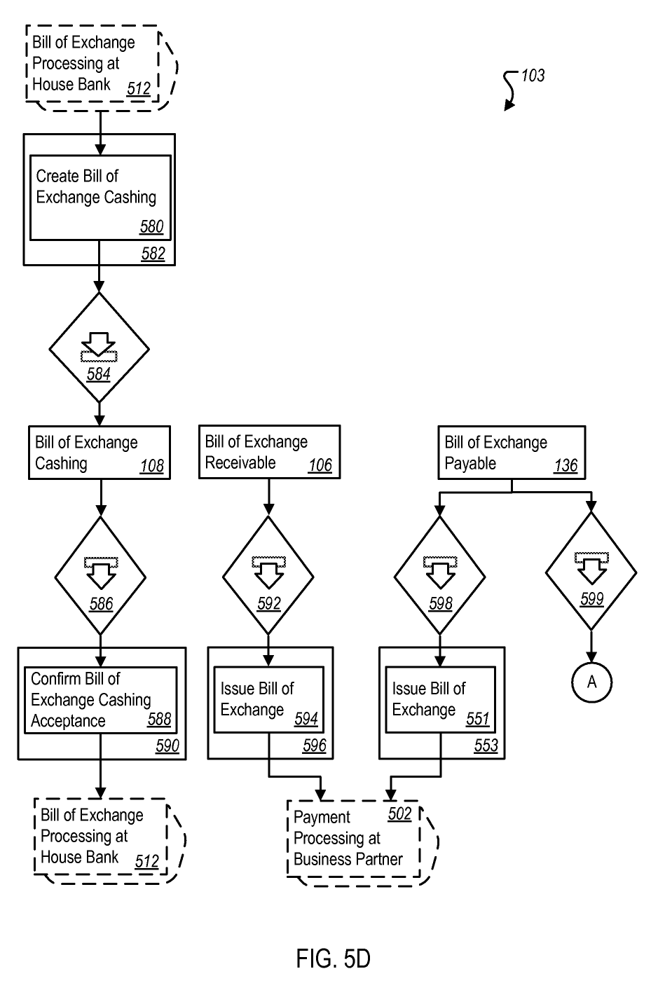

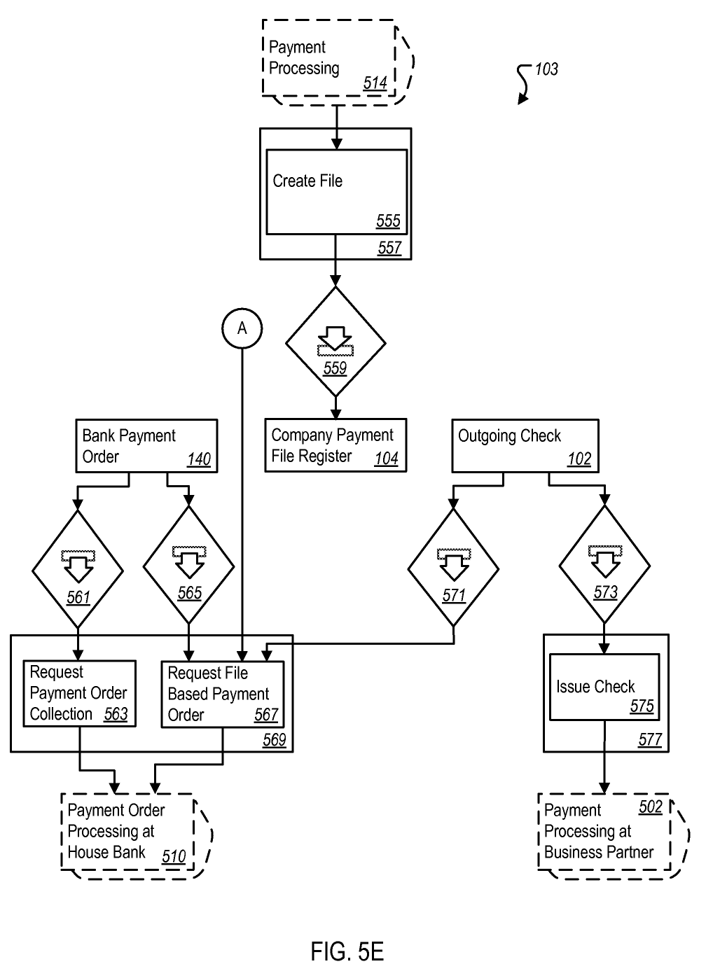

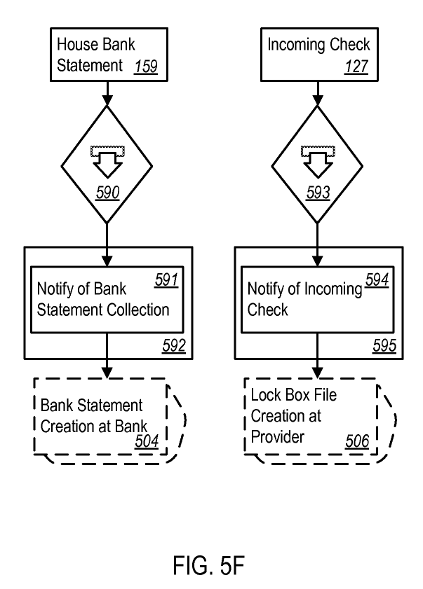

FIGS. 5A, 5B, 5C, 5D, 5E and 5F are block diagrams collectively showing the Payment Processing process component 103 (FIG. 1E). For convenience in describing this process component, a number of external process components are shown in the figures; these other process components are not part of the process components being described. These other process components are the Due Item Processing process component 105, a Payment Processing at Business Partner process component 502, a Bank Statement Creation at Bank process component 504, a Lock Box File Creation at Provider process component 506, a Settlement Processing at Clearing House process component 508, a Payment Order Processing at House Bank process component 510, a Bill of Exchange Processing at House Bank process component 512 and a Payment Processing process component 514.

As shown in FIG. 5A, the Due Item Processing process component 105 invokes a Change Payment Allocation Based on Clearing Request Confirmation operation 516. The Change Payment Allocation Based on Clearing Request Confirmation operation 516 confirms the execution or rejection of a sent clearing request. The operation 516 is included in a Clearing In interface 518. The operation 516 uses a Change Payment Allocation Based On Clearing Request Confirmation inbound process agent 520 to update the Payment Allocation business object 103A.

The Payment Order business object 101 uses a Notify of Payment From Payment Order to Business Partner outbound process agent 522 to invoke a Notify of Payment operation 524. The Notify of Payment operation 524 sends data that allows the assignment of payments to receivables or payables at the business partner. The operation 524 is included in an Outgoing Payment Advicing Out interface 526. The operation 524 updates the Payment Processing at Business Partner process component 502.

The Payment Allocation business object 103A uses a Request Clearing Maintenance From Payment Allocation to Due Item Processing inbound process agent 528 to invoke a Request Clearing operation 530 or a Request Clearing Cancellation operation 532. The Request Clearing operation 530 requests the clearing of payments within the Due Item Processing process component 105. The Request Clearing Cancellation operation 532 cancels a previously sent clearing request within the Due Item Processing process component 105 by reference. The operations 530, 532 are included in a Clearing Out interface 534. The operations 530, 532 update the Due Item Processing process component 105.

As shown in FIG. 5A, several business objects are included in the Payment Processing process component 103, but are not shown in the interactions. These business objects include the Cash Storage business object 157, the Check Storage business object 189, the Bill of Exchange Storage business object 129, the House Bank Account business object 197, the Payment Media Run business object 114, the Payment Media Deposit Creation Run business object 104A, the Payment Card Payment Settlement Run business object 120, and the Payment Register business object 110.

As shown in FIG. 5B, the Bank Statement Creation at Bank process component 504 invokes a Create Bank Statement Collection operation 536 or a Create Bank Statement operation 538. The Create Bank Statement Collection operation 536 creates a collection of bank statements in Payment Processing. The Create Bank Statement operation 538 creates a bank statement in Payment Processing. The operations 536 and 538 are included in a Bank Statement Processing In interface 540. The operations 536 and 538 use a Maintain Bank Statement inbound process agent 542 to update the House Bank Statement business object 159.

The Payment Processing at Business Partner process component 502 invokes a Create Payment Advice operation 544. The Create Payment Advice operation 544 creates a payment advice sent from a business partner or house bank concerning future payment transactions. The operation 544 is included in an Incoming Payment Advicing In interface 546. The operation 544 uses a Maintain Payment Advice inbound process agent 548 to update the Payment Advice business object 101A.

The Lock Box File Creation at Provider process component 506 invokes a Create Incoming Check operation 550. The Create Incoming Check operation 550 creates incoming checks by processing lockbox data. The operation 550 is included in an Incoming Check Processing In interface 552. The operation 550 uses a Maintain Incoming Check inbound process agent 554 to update the Incoming Check business object 127.

As shown in FIG. 5C, the Settlement Processing at Clearing House process component 508 invokes a Change Clearing House Payment Order Based On Settlement Confirmation operation 556. The Change Clearing House Payment Order Based On Settlement Confirmation operation 556 updates the status of a clearing house payment order according to the settlement confirmation. The operation 556 is included in a Payment Card Payment Settling In interface 558. The operation 556 uses a Change Clearing House Payment Order Based On Settlement Confirmation inbound process agent 560 to update the Clearing House Payment Order business object 112.

The Check Deposit business object 132 uses a Request Check Deposit to House Bank outbound process agent 562 to invoke a Request Check Deposit operation 564. The Request Check Deposit operation 564 requests the deposit of a collection of incoming checks to be sent to the house bank for crediting on the house bank account. The operation 564 is included in a Check Depositing Output Out interface 566. The operation 564 updates the Payment Order Processing at House Bank process component 510.

The Clearing House Payment Order business object 112 uses a Request Payment Card Settlement From Clearing House Payment Order outbound process agent 568 to invoke a Request Payment Card Payment Settlement operation 570. The Request Payment Card Payment Settlement operation 570 send a collection of payment card payments to be credited to the clearing house. The operation 570 is included in a Payment Card Payment Settling Out interface 572. The operation 570 updates the Settlement Processing at Clearing House process component 508.

The Bill of Exchange Deposit business object 134 uses a Request Bill of Exchange Deposit to House Bank outbound process agent 574 to invoke a Request Bill of Exchange Deposit operation 576. The Request Bill of Exchange Deposit operation 576 requests the deposit of a collection of bills of exchange receivable to be sent to the house bank for crediting on the house bank account. The operation 576 is included in a Bill of Exchange Depositing Out interface 578. The operation 576 updates the Payment Order Processing at House Bank process component 510.

As shown in FIG. 5D, the Bill of Exchange Processing at House Bank process component 512 invokes a Create Bill of Exchange Cashing operation 580. The Create Bill of Exchange Cashing operation 580 creates a bill of exchange cashing that has to be accepted. The operation 580 is included in a Bill of Exchange Cashing In interface 582. The operation 580 uses a Create Bill of Exchange Cashing inbound process agent 584 to update the Bill of Exchange Cashing business object 108.

The Bill of Exchange Cashing business object 108 uses a Confirm Bill of Exchange Cashing Acceptance to House Bank outbound process agent 586 to invoke a Confirm Bill of Exchange Cashing Acceptance operation 588. The Confirm Bill of Exchange Cashing Acceptance operation 588 accepts a bill of exchange cashing. The operation 588 is included in a Bill of Exchange Cashing Out interface 590. The operation 588 updates the Bill of Exchange Processing at House Bank process component 512.

The Bill of Exchange Receivable business object 106 uses an Issue Bill of Exchange Receivable to Business Partner outbound process agent 592 to invoke an Issue Bill of Exchange operation 594. The Issue Bill of Exchange operation 594 requests the issuing of a bill of exchange. The operation 594 is included in a Bill of Exchange Receivable Issuing Output Out interface 596. The operation 594 updates the Payment Processing at Business Partner process component 502.

The Bill of Exchange Payable business object 136 uses an Issue Bill of Exchange Payable to Business Partner outbound process agent 598 to invoke an Issue Bill of Exchange operation 551. The Issue Bill of Exchange operation 551 requests the issuing of a bill of exchange. The operation 551 is included in a Bill of Exchange Payable Issuing Output Out interface 553. The operation 551 updates the Payment Processing at Business Partner process component 502.

The Bill of Exchange Payable business object 136 uses a Request File Based Payment Order From Bill of Exchange Payable to House Bank outbound process agent 599 to invoke a Request File Based Payment Order operation 567, as shown in FIG. 5E. The Request File Based Payment Order operation 567 instructs a house bank by file to make a bank transfer, direct debit, outgoing check, or bill of exchange payable. The operation 567 is included in a Payment Ordering Out interface 569. The operation 567 updates the Payment Order Processing at House Bank process component 510.

As shown in FIG. 5E, the Bank Payment Order business object 140 uses a Request Payment Order Collection From Bank Payment Order to House Bank outbound process agent 561 to invoke a Request Payment Order Collection operation 563. The Request Payment Order Collection operation 563 sends a collection of bank transfers or direct debits for payment submission to the business partner. The operation 563 is included in the Payment Ordering Out interface 569. The operation 563 updates the Payment Order Processing at House Bank process component 510.

The Bank Payment Order business object 140 uses a Request File Based Payment Order From Bank Payment Order to House Bank outbound process agent 565 to invoke the Request File Based Payment Order operation 567. The Request File Based Payment Order operation 567 instructs a house bank by file to make a bank transfer, direct debit, outgoing check, or bill of exchange payable. The operation 567 is included in the Payment Ordering Out interface 569. The operation 567 updates the Payment Order Processing at House Bank process component 510.

The Payment Processing process component 514 invokes a Create File operation 555. The Create File operation 555 creates a file for a request based on a file transfer to a credit institution to carry out one or more payment transactions, such as bank transfers or direct debits. The operation 555 is included in a File Creation For Payment Ordering In interface 557. The operation 555 uses a Maintain File For Payment Ordering inbound process agent 559 to update the Company Payment File Register business object 104.

The Outgoing Check business object 102 uses a Request File Based Payment Order From Outgoing Check to House Bank outbound process agent 571 to invoke the Request File Based Payment Order operation 567. The Request File Based Payment Order operation 567 instructs a house bank by file to make a bank transfer, direct debit, outgoing check, or bill of exchange payable. The operation 567 is included in the Payment Ordering Out interface 569. The operation 567 updates the Payment Order Processing at House Bank process component 510.

The Outgoing Check business object 102 uses an Issue Check From Outgoing Check to Business Partner outbound process agent 573 to invoke an Issue Check operation 575. The Issue Check operation 575 request the issuing of a check by creating the print form. The operation 575 is included in a Check Issuing Output Out interface 577. The operation 575 updates the Payment Processing at Business Partner process component 502.

As shown in FIG. 5F, the House Bank Statement business object 159 uses a Notify of Bank Statement Collection outbound process agent 590 to invoke a Notify of Bank Statement Collection operation 591. The Notify of Bank Statement Collection operation 591 notifies about a collection of bank statements in the Payment Processing process component 103. The operation 591 is included in a Bank Statement Processing Out interface 592. The Notify of Bank Statement Collection operation 591 updates the Bank Statement Creation at Bank process component 504.

The Incoming Check business object 127 uses an Incoming Check Processing Out outbound process agent 593 to invoke a Notify of Incoming Check operation 594. The Notify of Incoming Check operation 594 notifies about incoming checks created by processing lockbox data. The operation 594 is included in a Incoming Check Processing Out interface 595. The Notify of Incoming Check operation 594 updates the Lock Box File Creation at Provider process component 506.

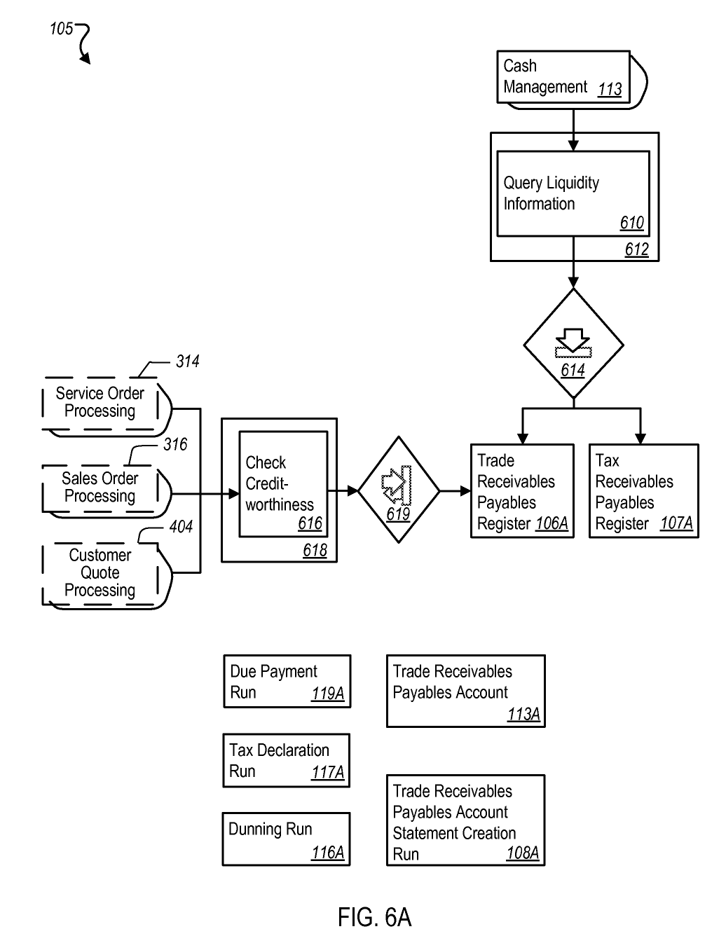

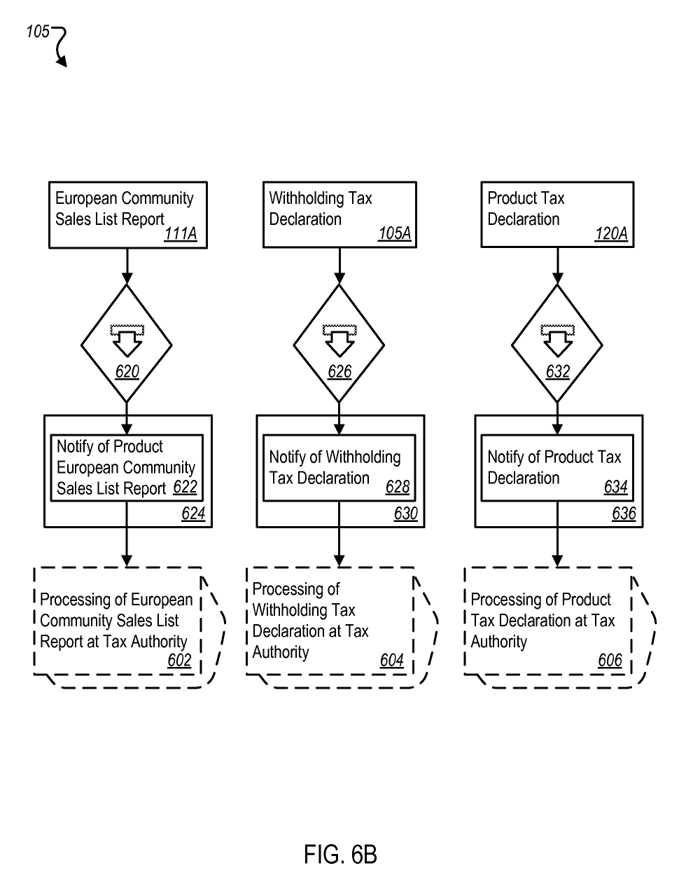

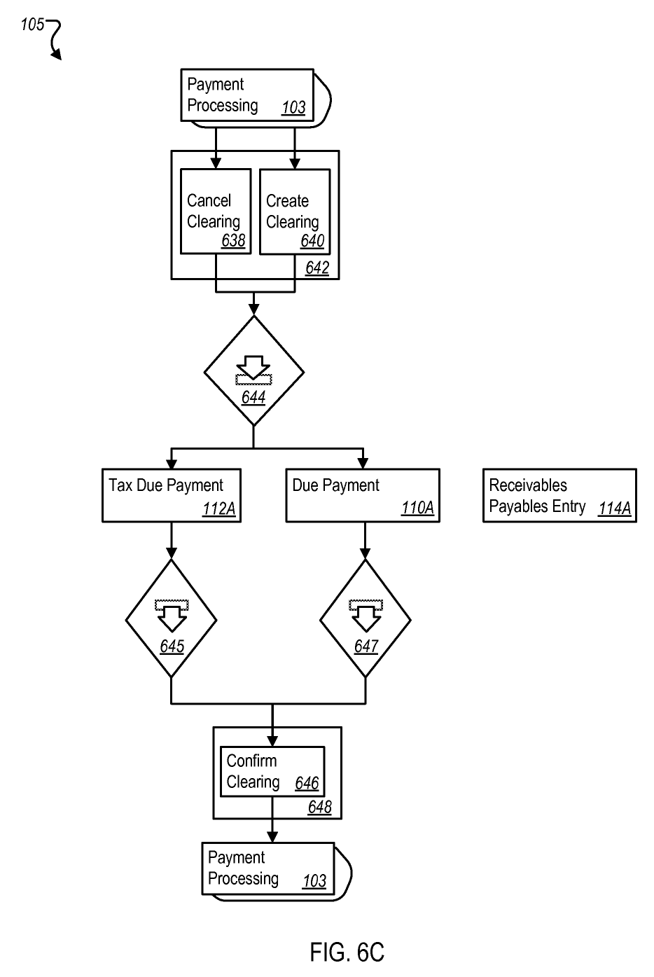

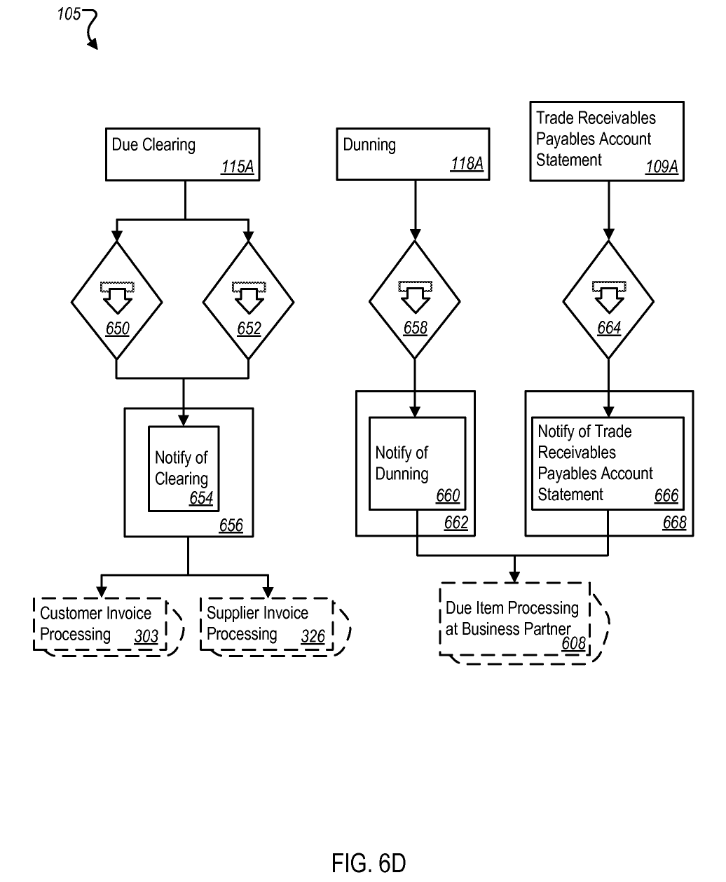

FIGS. 6A, 6B, 6C and 6D are block diagrams collectively showing the Due Item Processing process component 105 (FIG. 1F). For convenience in describing this process component, a number of external process components are shown in the figures; these other process components are not part of the process components being described. These other process components are the Service Order Processing process component 314, the Sales Order Processing process component 316, the Customer Quote Processing process component 404, the Cash Management process component 113, a Processing of European Community Sales List Report at Tax Authority process component 602, a Processing of Withholding Tax Declaration at Tax Authority process component 604, a Processing of Product Tax Declaration at Tax Authority process component 606, the Payment Processing process component 103, the Customer Invoice Processing process component 303, the Supplier Invoice Processing process component 326, and a Due Item Processing at Business Partner process component 608.

As shown in FIGS. 6A and 6C, several business objects are included in the Due Item Processing process component 105, but are not shown in the interactions. These include the Due Payment Run business object 119A, the Tax Declaration Run business object 117A, the Dunning Run business object 116A, the Trade Receivables Payables Account business object 113A, the Trade Receivables Payables Account Statement Creation Run business object 108A, and the Receivables Payables Entry business object 114A.

As shown in FIG. 6A, the Service Order Processing process component 314, the Sales Order Processing process component 316 and the Customer Quote Processing process component 404 invoke a Check Creditworthiness operation 616. The Check Creditworthiness operation 616 initiates the execution of a credit check. The operation 616 is included in a Credit Usage In interface 618. The operation 616 uses a Check Creditworthiness Based on Trade Receivables Payables Register synchronous inbound process agent 619 to update the Trade Receivables Payables Register business object 106A.

The Cash Management process component 113 invokes a Query Liquidity Information operation 610. The Query Liquidity Information operation 610 queries liquidity information from relevant process components. The operation 610 is included in a Liquidity Information Out interface 612. The operation 610 uses a Sync Query Liquidity Information From Due Item Processing inbound process agent 614 to update the Trade Receivables Payables Register business object 106A and the Tax Receivables Payables Register business object 107A.

As shown in FIG. 6B, the European Community Sales List Report business object 111A uses a Notify of European Community Sales List Report to Tax Authority outbound process agent 620 to invoke a Notify of Product European Community Sales List Report operation 622. The Notify of Product European Community Sales List Report operation 622 sends a European Community Sales List Report to the tax authority. The operation 622 is included in a European Community Sales List Report Out interface 624. The operation 622 updates the Processing of European Community Sales List Report at Tax Authority process component 602.

The Withholding Tax Declaration business object 105A uses a Notify of Withholding Tax Declaration to Tax Authority outbound process agent 626 to invoke a Notify of Withholding Tax Declaration operation 628. The Notify of Withholding Tax Declaration operation 628 sends a withholding tax declaration to a financial authority. The operation 628 is included in a Withholding Tax Declaration Out interface 630. The operation 628 updates the Processing of Withholding Tax Declaration at Tax Authority process component 604.

The Product Tax Declaration business object 120A uses a Notify of Product Tax Declaration to Tax Authority outbound process agent 632 to invoke a Notify of Product Tax Declaration operation 634. The Notify of Product Tax Declaration operation 634 sends a value added tax (VAT) declaration to a financial authority. The operation 634 is included in a Product Tax Declaration Out interface 636. The operation 634 updates the Processing of Product Tax Declaration at Tax Authority process component 606.

As shown in FIG. 6C, the Payment Processing process component 103 invokes a Cancel Clearing operation 638 or a Create Clearing operation 640. The Cancel Clearing operation 638 cancels a previously sent clearing request by reference. The Create Clearing operation 640 create a clearing for business partner-initiated payments. The operations 638 and 640 are included in a Clearing In interface 642. The operations 638 and 640 use a Maintain Clearing inbound process agent 644 to update the Tax Due Payment business object 112A and the Due Payment business object 110A.

The Tax Due Payment business object 112A uses a Confirm Clearing From Tax Due Payment to Payment Processing outbound process agent 645 to invoke a Confirm Clearing operation 646. The Due Payment business object 110A uses a Confirm Clearing From Due Payment to Payment Processing outbound process agent 647 to invoke the Confirm Clearing operation 646. The Confirm Clearing operation 646 sends a confirmation to Payment Processing for a clearing request. The operation 646 is included in a Clearing Out interface 648. The operation 646 updates the Payment Processing process component 103.

As shown in FIG. 6D, the Due Clearing business object 115A uses a Notify of Clearing to Customer Invoice Processing outbound process agent 650 and/or a Notify of Clearing to Supplier Invoice Processing outbound process agent 652 to invoke a Notify of Clearing operation 654. The Notify of Clearing operation 654 notifies Customer Invoice Processing and Supplier Invoice Processing about clearing of trade receivables. The operation 654 is included in a Due Clearing Out interface 656. The operation 654 updates the Customer Invoice Processing process component 303 and the Supplier Invoice Processing process component 326.

The Dunning business object 118A uses a Notify of Dunning to Business Partner outbound process agent 658 to invoke a Notify of Dunning operation 660. The Notify of Dunning operation 660 notifies the business partner about outstanding payments. The operation 660 is included in a Dunning Output Out interface 662. The operation 660 updates the Due Item Processing at Business Partner process component 608.

The Trade Receivables Payables Account Statement business object 109A uses a Notify of Trade Receivables Payables Account Statement to Business Partner outbound process agent 664 to invoke a Notify of Trade Receivables Payables Account Statement operation 666. The Notify of Trade Receivables Payables Account Statement operation 666 notifies the business partner about receivables and payables on the business partner's account. The operation 666 is included in a Trade Receivables Payables Account Statement Out interface 668. The operation 666 updates the Due Item Processing at Business Partner process component 608.

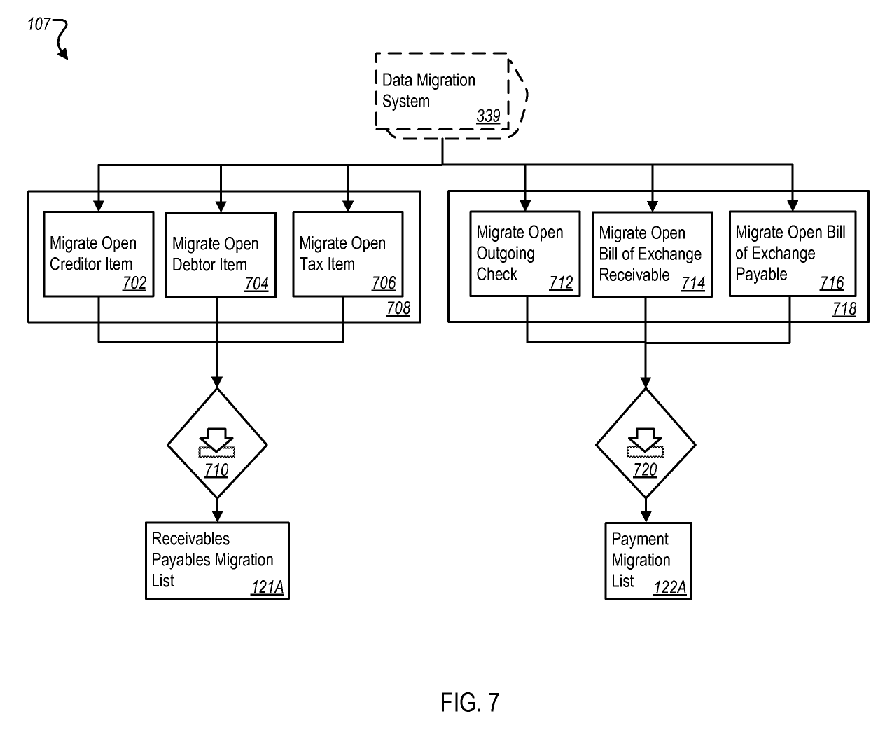

FIG. 7 is a block diagram showing the Migration Data Dispatching process component 107 (FIG. 1G). The Migration Data Dispatching process component 107 processes data that must be migrated to more than one deployment unit and that must be kept consistent across the deployment units. The processing of this data is a one-off activity that occurs before go-live.

As shown in FIG. 7, the Data Migration System process component 339 invokes a Migrate Open Creditor Item operation 702, a Migrate Open Debtor Item operation 704, and/or a Migrate Open Tax Item operation 706. The Migrate Open Creditor Item operation 702 converts information about open creditor items from a data migration system into a receivables payables migration list to forward this information to Due Item Processing and Accounting. The Migrate Open Debtor Item operation 704 converts information about open debtor items from a data migration system into a receivables payables migration list to forward this information to Due Item Processing and Accounting. The Migrate Open Tax Item operation 706 converts information about open tax items from a data migration system into a receivables payables migration list to forward this information to Due Item Processing and Accounting. The operations 702, 704, and 706 are included in a Receivables Payables Migration List Migration In interface 708. The operations 702, 704, and 706 use a Migrate Receivables Payables Migration List inbound process agent 710 to update the Receivables Payables Migration List business object 121A. The process agent 710 sends open debtor, creditor, or tax items to the receivables and payables migration list.

The Data Migration System process component 339 invokes a Migrate Open Outgoing Check operation 712, a Migrate Open Bill of Exchange Receivable operation 714, and/or a Migrate Open Bill of Exchange Payable operation 716. The Migrate Open Outgoing Check operation 712 converts information about open outgoing checks from a data migration system into a payment migration list to forward this information to payment processing and accounting. The Migrate Open Bill of Exchange Receivable operation 714 converts information about open bills of exchange receivable from a data migration system into a payment migration list to forward this information to payment processing and accounting. The Migrate Open Bill of Exchange Payable operation 716 converts information about open bills of exchange payable from a data migration system into a payment migration list to forward this information to payment processing and accounting. The operations 712, 714, and 716 are included in a Payment Migration List Migration In interface 718. The operations 712, 714, and 716 use a Migrate Payment Migration List inbound process agent 720 to update the Payment Migration List business object 122A. The Migrate Payment Migration List inbound process agent 720 sends open payments to the payment migration list.

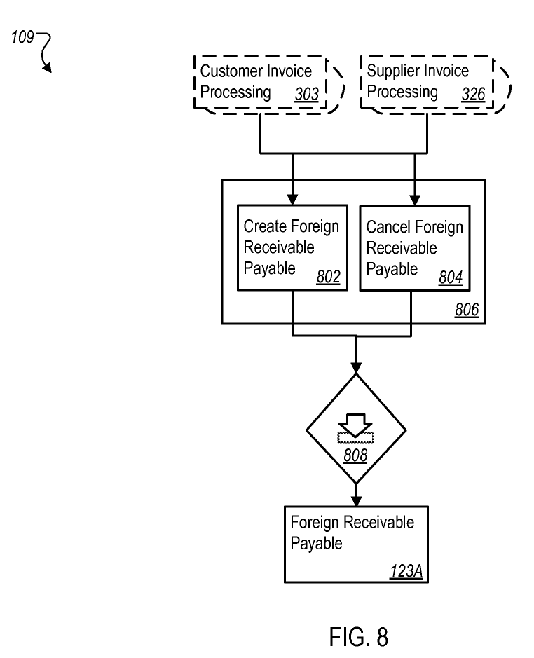

FIG. 8 is a block diagram showing the Balance of Foreign Payment Management process component 109 (FIG. 1G). The Balance of Foreign Payment Management process component 109 handles the collection, processing, and reporting of receivables and payables according to foreign trade regulations that are required by the financial authority of a country, such as the central bank.

As shown in FIG. 8, the Customer Invoice Processing process component 303 and the Supplier Invoice Processing process component 326 invokes a Create Foreign Receivable Payable operation 802 and/or a Cancel Foreign Receivable Payable operation 804. The Create Foreign Receivable Payable operation 802 creates a receivable or payable from foreign trade. The Cancel Foreign Receivable Payable operation 804 provides a notification about the cancellation of a receivable (customer invoice) related to a non-resident buyer. The operations 802 and 804 are included in a Foreign Receivable Payable Notification In interface 806. The operations 802 and 804 use a Maintain Foreign Receivable Payable inbound process agent 808 to update the Foreign Receivable Payable business object 123A. The process agent 808 creates, changes, or cancels a receivable or payable from a foreign trade.

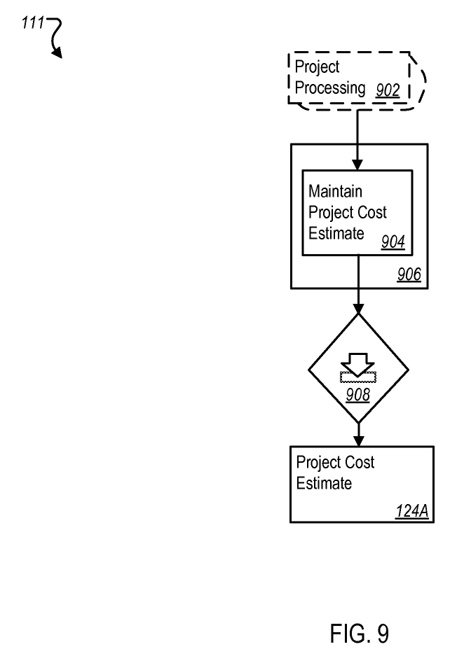

FIG. 9 is a block diagram showing the Costing process component 111 (FIG. 1G). The Costing process component 111 estimates costs for objects such as materials, projects, service products, sales order items, or production lots.

As shown in FIG. 9, a Project Processing process component 902 invokes a Maintain Project Cost Estimate operation 904. The Maintain Project Cost Estimate operation 904 generates or updates a Financial Accounting View of Project business object due to the generation of or change to a project and to generate or change a Project Cost Estimate business object if costing should be performed immediately. The operation 904 is included in a Project Costing In interface 906. The operation 904 uses a Maintain Project Cost Estimate and Financial Accounting View of Project inbound process agent 908 to update the Project Cost Estimate business object 124A.

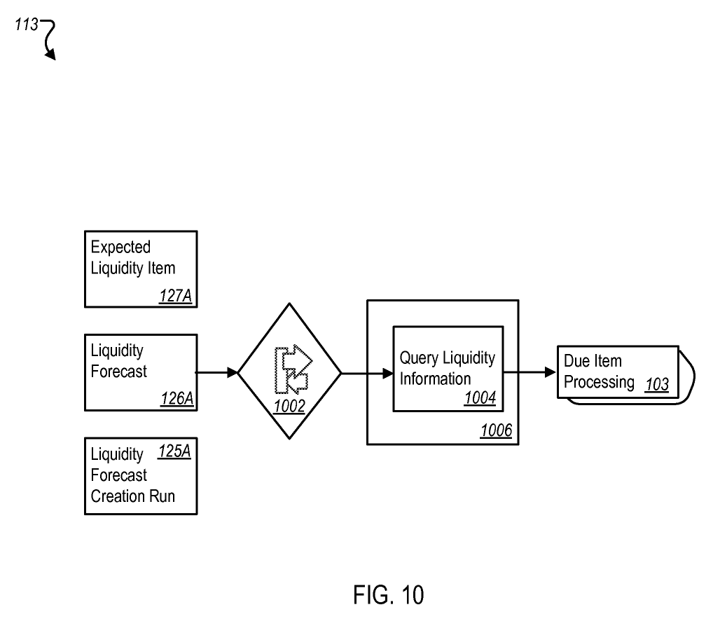

FIG. 10 is a block diagram showing the Cash Management process component 113 (FIG. 1G). The Cash Management process component 113 handles the analysis and management of current and future liquidity. A number of business objects are included in the Cash Management process component 113, but are not shown in the interactions. These include the Liquidity Forecast Creation Run business object 125A and the Expected Liquidity Item business object 127A.

As shown in FIG. 10, the Liquidity Forecast business object 126A uses a Sync Query Liquidity Information From Liquidity Forecast to Due Item Processing outbound process agent 1002 to invoke a Query Liquidity Information operation 1004. The Query Liquidity Information operation 1004 queries liquidity information from relevant process components. The operation 1004 is included in a Liquidity Information Out interface 1006. The operation 1004 updates the Due Item Processing process component 103.

The subject matter described in this specification and of the functional operations described in this specification can be implemented in digital electronic circuitry, or in computer software, firmware, or hardware, including the structural means disclosed in this specification and structural equivalents thereof, or in combinations of them. The subject matter described in this specification can be implemented as one or more computer program products, i.e., one or more computer programs tangibly embodied in an information carrier, e.g., in a machine-readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The subject matter described in this specification can be implemented in a computing system that includes a back-end component (e.g., a data server), a middleware component (e.g., an application server), or a front-end component (e.g., a client computer having a graphical user interface or a Web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of the invention or of what may be claimed, but rather as illustrating preferred embodiments of the invention. Certain features that are described in this specification in the context of separate embodiments may also be provided in combination in a single embodiment. Conversely, various features that are described in the context of a single embodiment may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter has been described in terms of particular variations, but other variations can be implemented and are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other variations are within the scope of the following claims.

What is claimed is:

1. A computer readable medium including program code for providing message-based services using a service-oriented methodology for implementing an instance of a deployment unit, the medium comprising:
program code for storing an instance of a financials deployment unit for recording and valuation of business transactions, and the estimation of costs and profits, for both financial and management accounting, where the financials deployment unit defines the limits of an application-defined transaction for recording and valuation of business transactions, and the estimation of costs and profits, for both financial and management accounting by a set of actions that have atomicity, consistency, isolation, and durability in a database, and where the actions associated with the application-defined transaction are performed by one or more process components contained in the financials deployment unit, wherein each process component comprises a software package realizing a business process and exposing its functionality as one or more service operations, wherein the financials deployment unit comprises:
an accounting process component, wherein the accounting process component implements the following service operations:
a first create accounting notification operation related to production data;
a second create accounting notification operation related to sales and purchasing data;
a first create accounting document operation related to goods movement or resource consumption data;
a first cancel accounting document operation related to goods movement or resource consumption data;
a second create accounting document operation related to inventory data, a second cancel accounting document operation related to inventory data;
a third create accounting document operation related to resource consumption data;
a third cancel accounting document operation related to resource consumption data;
a fourth create accounting document operation related to invoice data;
a fourth cancel accounting document operation related to invoice data;
a fifth create accounting document operation related to expense data
a fifth cancel accounting document operation related to expense data;
a transmit accounts receivable operation;
a transmit accounts payable operation;
a notify of balance sheet and income statement operation;
a notify of account balance report operation;
a notify of accounting document report operation;
a notify of cash flow statement operation, a notify of China (CN) golden audit report operation;
a migrate open goods receipt operation;
a migrate account balance operation;
a migrate fixed asset operation; and
a manage accounting entry in maintain as bundle operation;
a financial accounting master data management process component, wherein the financial accounting master data management process component implements the following service operations:
a transmit material valuation data operation;
a transmit service product valuation data operation; and
a sync valuate product and resource operation;
a payment processing process component, wherein the payment processing process component implements the following service operations:
a change payment allocation based on clearing request confirmation operation;
a notify of payment operation;
a request clearing operation;
a request clearing cancellation operation;
a create bank statement collection operation;
a create bank statement operation;
a create payment advice operation;
a create incoming check operation;
a change clearing house payment order based on settlement confirmation operation;
a request check deposit operation;
a request payment card payment settlement operation;
a request bill of exchange deposit operation;
a create bill of exchange cashing operation;
a confirm bill of exchange cashing acceptance operation;
a first issue bill of exchange operation related to bill of exchange receivable data;
a second issue bill of exchange operation related to bill of exchange payable data;
a create file operation;
a request payment order collection operation;
a request file based payment order operation;
an issue check operation;
a notify of bank statement collection operation; and
a notify of incoming check operation;
a due item processing process component, wherein the due item processing process component implements the following service operations:
a query liquidity information operation;
a check creditworthiness operation;
a notify of European community sales list report operation;
a notify of withholding tax declaration operation;
a notify of product tax declaration operation;
a cancel clearing operation, a create clearing operation;
a confirm clearing operation;
a notify of clearing operation;
a notify of dunning operation; and
a notify of trade receivables payables account statement operation;
a migration data dispatching process component, wherein the migration data dispatching process component implements the following service operations:
a migrate open outgoing check operation;
a migrate open debtor item operation;
a migrate open creditor item operation;
a migrate open bill of exchange receivable operation; and
a migrate open tax item operation, a migrate open bill of exchange payable operation;
a balance of foreign payment management process component, wherein the balance of foreign payment management process component implements the following service operations:
a cancel foreign receivable payable operation; and
a create foreign receivable payable operation;
a costing process component, wherein the costing process component implements a maintain project cost estimate service operation; and
a cash management process component, wherein the cash management process component implements a query liquidity information service operation;
wherein the process components of the financials deployment unit are packaged together to be deployed on a single computer system;
program code for executing the application-defined transaction for recording and valuation of business transactions, and the estimation of costs and profits, for both financial and management accounting; and
program code for presenting data associated with the executed application-defined transaction for recording and valuation of business transactions, and the estimation of costs and profits, for both financial and management accounting to a graphical user interface.

2. The medium of claim 1, wherein the accounting process component comprises a purchase ledger account business object, a cash ledger account business object, an accounting document business object, a sales ledger account business object, an accounting notification business object, an accounting entry business object, a material ledger account business object, a production ledger account business object, an accounting adjustment run common part business object, an other direct cost ledger account business object, a fixed asset business object, an overhead cost ledger account business object, a general ledger account business object, an accounts receivable payable ledger account business object, a tax ledger account business object, a fixed asset depreciation run mass data run object, an inventory price change run mass data run object, a work in process clearing run mass data run object, a production ledger account overhead cost calculation run mass data run object, a goods receipt invoice receipt clearing run mass data run object, a sales ledger account overhead cost calculation run mass data run object, a sales ledger account accruals run mass data run object, a balance sheet and income statement report business object, an accounts receivable payable ledger account regrouping run mass data run object, a balance carry forward run mass data run object, an accounting document report business object, an accounting document report run mass data run object, an accounts receivable payable ledger account foreign currency re-measurement run mass data run object, a cash ledger account foreign currency re-measurement run mass data run object, an overhead cost assessment run business object, an account balance report business object, an overhead cost ledger account overhead cost calculation run mass data run object, an accounting clearing object history business object, an other direct cost ledger account overhead cost calculation run business object, an accounting data collection for export result business object, a cash flow statement business object, an accounting statutory report run business object, an accounting entry recurrence definition business object, an accounting business transaction run business object, an accounting data collection for export run business object, a miscellaneous subledger account business object, a China (CN) golden audit report business object, an accounting processing error business object, a recurring accounting entry run business object, and an accounting reconciliation run business object.

3. The medium of claim 1, wherein the financial accounting master data management process component comprises a service product valuation data business object, a material valuation data business object, a resource valuation data business object, an overhead cost scheme business object, a financial accounting view of project business object, an overhead cost assessment rule business object, a set of books business object, a financial accounting view of purchasing document business object, a financial accounting view of production document business object, and a financial accounting view of sales and service document business object.

4. The medium of claim 1, wherein the payment processing process component comprises a payment order business object, an incoming check business object, a bill of exchange storage business object, a cash storage business object, a house bank statement business object, an outgoing check business object, a payment card payment settlement run business object, a company payment file register business object, a bill of exchange receivable business object, a bill of exchange cashing business object, a payment register business object, a clearing house payment order business object, a check deposit business object, a bill of exchange deposit business object, a bill of exchange payable business object, a payment media run business object, a house bank account business object, a bank payment order business object, a check storage business object, a payment advice business object, a cash transfer business object, a payment allocation business object, and a payment media deposit creation run business object

5. The medium of claim 1, wherein the due item processing process component comprises a withholding tax declaration business object, a trade receivables payables register business object, a tax receivables payables register business object, a trade receivables payables account statement creation run business object, a trade receivables payables account statement business object, a due payment business object, a European community sales list report business object, a tax due payment business object, a trade receivables payables account business object, a receivables payables entry business object, a due clearing business object, a dunning run business object, a tax declaration run business object, a dunning business object, a due payment run business object, and a product tax declaration business object.

6. The medium of claim 1, wherein the migration data dispatching process component comprises a payables migration list business object and a payment migration list business object.

7. The medium of claim 1, wherein the balance of foreign payment management process component comprises a foreign receivable payable business object.

8. The medium of claim 1, wherein the costing process component comprises a project cost estimate business object

9. The medium of claim 1, wherein the cash management process component comprises a liquidity forecast creation run business object, a liquidity forecast business object, and an expected liquidity item business object

10. The medium of claim 1, wherein the services operations associated with the accounting process component are grouped into service interfaces, the service interfaces comprising:
a production accounting in interface that includes the first create accounting notification operation related to production data;
a sales and purchasing accounting in interface that includes the second create accounting notification operation related to sales and purchasing data;
a goods and service accounting in interface that includes the first create accounting document operation related to goods movement or resource consumption data and the first cancel accounting document operation related to goods movement or resource consumption data;
an inventory and activity accounting in interface that includes the second create accounting document operation related to inventory data and the second cancel accounting document operation related to inventory data;
a service provision accounting in interface that includes the third create accounting document operation related to resource consumption data and the third cancel accounting document operation related to resource consumption data;
an invoice accounting in interface that includes the fourth create accounting document operation related to invoice data and the fourth cancel accounting document operation related to invoice data;
an expense accounting in interface that includes the fifth create accounting document operation related to expense data and the fifth cancel accounting document operation related to expense data;
an accounts receivable payable ledger account transmission in interface that includes the transmit accounts receivable and the transmit accounts payable operations;
a balance sheet and income statement out interface that includes the notify of balance sheet and income statement operation;
an account balance report out interface that includes the notify of account balance report operation;
an accounting document report out interface that includes the notify of accounting document report operation;
a cash flow statement out interface that includes the notify of cash flow statement operation;
a China (CN) golden audit report out interface that includes the notify of China (CN) golden audit report operation;
an open goods receipt migration in interface that includes the migrate open goods receipt operation;
an account balance migration in interface that includes the migrate account balance operation;
a fixed asset migration in interface that includes the migrate fixed asset operation; and
a manage accounting entry in interface that includes the manage accounting entry in maintain as bundle operation.

11. The medium of claim 1, wherein the services operations associated with the financial accounting master data management process component are grouped into service interfaces, the service interfaces comprising:
a material valuation data transmission in interface that includes the transmit material valuation data and the transmit service product valuation data operations; and
a product and resource valuation in interface that includes the synchronous valuate product and resource operation.

12. The medium of claim 1, wherein the services operations associated with the payment processing process component are grouped into service interfaces, the service interfaces comprising:
a clearing in interface that includes the change payment allocation based on clearing request confirmation operation;
an outgoing payment advicing out interface that includes the notify of payment operation;
a first clearing out interface that includes the request clearing and the request clearing cancellation operations;
a bank statement processing in interface that includes the create bank statement collection and the create bank statement operations;
an incoming payment advicing in interface that includes the create payment advice operation;
an incoming check processing in interface that includes the create incoming check operation;
a payment card payment settling in interface that includes the change clearing house payment order based on settlement confirmation operation;
a check depositing output out interface that includes the request check deposit operation;
a payment card payment settling out interface that includes the request payment card payment settlement operation;
a bill of exchange depositing out interface that includes the request bill of exchange deposit operation;
a bill of exchange cashing in interface that includes the create bill of exchange cashing operation;
a bill of exchange cashing out interface that includes the confirm bill of exchange cashing acceptance operation;
a bill of exchange receivable issuing output out interface that includes the first issue bill of exchange operation related to bill of exchange receivable data;
a bill of exchange payable issuing output out interface that includes the second issue bill of exchange operation related to bill of exchange payable data;
a clearing out interface that includes the create file operation;
a payment ordering out interface that includes the request payment order collection operation;
a payment ordering out interface that includes the request file based payment order operation;
a check issuing output out interface that includes the issue check operation;
a bank statement processing out interface that includes the notify of bank statement collection operation; and
an incoming check processing out interface that includes the notify of incoming check operation.

13. The medium of claim 1, wherein the services operations associated with the due item processing process component are grouped into service interfaces, the service interfaces comprising:
a liquidity information in interface that includes the query liquidity information operation;
a dunning output out interface that includes the check creditworthiness operation;
a European community sales list report out interface that includes the notify of European community sales list report operation;
a withholding tax declaration out interface that includes the notify of withholding tax declaration operation;
a product tax declaration out interface that includes the notify of product tax declaration operation;
a clearing in interface that includes the cancel clearing operation and the create clearing operation;
a clearing out interface that includes the confirm clearing operation;
a first dunning output out interface that includes the notify of clearing operation;
a second dunning output out interface that includes the notify of dunning operation; and
a trade receivables payables account statement out interface that includes the notify of trade receivables payables account statement operation.

14. The medium of claim 1, wherein the services operations associated with the migration data dispatching process component are grouped into service interfaces, the service interfaces comprising:
a receivables payables migration list migration in interface that includes the migrate open creditor item, the migrate open debtor item, and the migrate open tax item operations; and
a payment migration list migration in interface that includes the migrate open outgoing check, the migrate open bill of exchange receivable, and the migrate open bill of exchange payable operations.

15. The medium of claim 1, wherein the services operations associated with the balance of foreign payment management process component are grouped into service interfaces, the service interfaces comprising:
a foreign receivable payable notification in interface that includes the cancel foreign receivable payable and the create foreign receivable payable operations.

16. The medium of claim 1, wherein the services operations associated with the costing process component are grouped into service interfaces, the service interfaces comprising a project costing in interface that includes the maintain project cost estimate operation.

17. The medium of claim 1, wherein the services operations associated with the cash management process component are grouped into service interfaces, the service interfaces comprising a liquidity information out interface that includes the query liquidity information operation.

18. The medium of claim 1, wherein the single computer system comprises a single physical hardware platform.
